(19) United States
(12) Patent Application Publication
(10) Pub. No.: US 2006/0246272 A1
(43) Pub. Date: Nov. 2, 2006

(54) Thermoplastic foam composite

(76) Inventors: Xiaomin X. Zhang, Appleton, WI (US); Jian Qin, Appleton, WI (US); Peiguang Zhou, Appleton, WI (US); Sridhar Ranganathan, Suwanee, GA (US); Charles Wilson Colman, Marietta, GA (US); Rob David Everett, Appleton, WI (US); Hoa La Wilhelm, Appleton, WI (US)

Correspondence Address: KIMBERLY-CLARK WORLDWIDE, INC., 401 NORTH LAKE STREET, NEENAH, WI, 54956, US

(21) Appl. No.: 11/117,864

(22) Filed: Apr. 29, 2005

(51) Int. Cl. B32B 3/26

(52) U.S. Cl. 428/304.4

(57) ABSTRACT

A thermoplastic foam composite has at least one active agent layer, which includes active agent materials that are coated with a thermal-sticky polymer, and which is bonded to at least one surface of a soft, flexible, absorbent thermoplastic foam layer. The thermoplastic foam composite can exhibit desirable active agent properties while maintaining sufficient integrity, absorbency, and/or flexibility for specific applications. In some aspects, an adhesive can be utilized to assist with bonding the active agent layer to the thermoplastic foam layer. The thermoplastic foam composite can be utilized as an article, such as a packaging, wiper, towel, or insulation product, or can be incorporated as a component into a variety of other articles, including personal care articles, health/medical articles, and household/industrial articles, for example.

### BACKGROUND

The present invention concerns foam composites. More particularly, the present invention pertains to soft, flexible, thermoplastic foam composites which can be utilized as an article, such as for packaging, wipers, towels and insulation products, or can be incorporated as a component into a variety of other articles, including personal care products, health/medical products, and household/industrial products, for example.

In general, the basic microporous structure provided by foams is different from that provided by conventional fibrous materials. For example, thermoplastic foams can have unique properties, such as low density, high open-cell percentage, softness and flexibility. These types of properties can be desirable for numerous applications, including absorbent-type products.

It may be desirable to include certain active agent materials with thermoplastic foams. However, it has been found that when such active agent materials are incorporated into the structure of thermoplastic foam, the cell walls and/or struts of the foam structure tend to encapsulate such materials, thus reducing the efficacy of the active agents. For example, in the case of active agents in the form of superabsorbent materials, the ability of the materials to fully swell may be hindered by encapsulation of the active agent materials by the foam cell membranes, which in turn can negatively impact absorbent properties. Therefore, there is a desire for a thermoplastic foam which can incorporate active agent materials in a manner such that encapsulation of the active agent material is reduced or eliminated.

Additionally, in the particular case of absorbent articles, it is recognized that such articles often include one or more absorbent layers capable of absorbing and retaining liquids. Some absorbent articles include a surge layer that is capable of quickly absorbing liquid, but is unable to retain a large quantity of liquid. A second absorbent layer having a higher absorbent capacity than the surge layer is often located below the surge layer such that the surge layer quickly takes in liquid and subsequently passes the liquid to the more absorbent layer to retain the liquid. Because of its many properties, such as aesthetics, flexibility, and absorbent properties, it may be desired to incorporate foams into such articles to perform at least one of the absorbing functions within the article. Therefore, there is a further desire for an article containing a thermoplastic foam incorporating active agent materials that has sufficiently high flexibility, fluid storage and fluid capillary action and does not experience a reduction in active agent efficacy associated with the foam.

### SUMMARY

The present invention concerns foam composites. More particularly, the present invention pertains to a thermoplastic foam composite comprising at least one active agent layer including active agent materials coated with a thermal-sticky polymer wherein the layer is bonded to at least one surface of a soft, flexible, absorbent thermoplastic foam layer. The result is a thermoplastic foam composite which can exhibit desirable active agent properties, while maintaining sufficient integrity, absorbency, and/or flexibility for specific applications. In some aspects, a thermoplastic elastomer can be utilized to enhance softness, flexibility and elasticity. In other aspects, a plasticizing agent and/or surfactant can be utilized to improve absorbent properties and open-cell content. In still other aspects, an adhesive can be utilized to assist with bonding the active agent layer to the thermoplastic foam layer. The thermoplastic foam composite of the present invention can be utilized as an article, such as a packaging, wiper, towel, or insulation product, or can be incorporated as a component into a variety of other articles, including personal care articles, health/medical articles, and household/industrial articles, for example.

### BRIEF DESCRIPTION OF THE DRAWINGS

The foregoing and other features, aspects and advantages of the present invention will become better understood with regard to the following description, appended claims and accompanying drawings where:

FIG. 1 is a photomicrograph of an enlarged schematic section through a portion of a thermoplastic foam layer in accordance with the invention. The photomicrograph was taken by scanning electron microscopy at a magnification of 30×;

FIG. 2 is an illustration of an exemplary process for making a thermoplastic foam layer;

FIG. 3 is an illustration of an exemplary process for hydraulic jet treating a foam layer;

FIG. 4 is a photomicrograph showing a surface of a thermoplastic foam layer in accordance with the present invention. The photomicrograph was taken at a magnification of 8×;

FIG. 5 is a photomicrograph showing a surface of a thermoplastic foam composite in accordance with the present invention. The photomicrograph was taken at a magnification of 8×;

FIG. 6 is a perspective view of one embodiment of an absorbent article that may be made in accordance with the present invention;

FIG. 7 is a plan view of the absorbent article shown in FIG. 6 with the article in an unfastened, unfolded and laid flat condition showing the surface of the article that faces the wearer when worn and with portions cut away to show underlying features;

FIG. 8 representatively shows a partially cut away top view of a Saturated Capacity tester;

FIG. 9 representatively shows a side view of a Saturated Capacity tester;

FIG. 10 representatively shows a rear view of a Saturated Capacity tester;

FIG. 11a representatively shows a front view of a Bending Modulus tester;

FIG. 11b is a perspective view of the Fixture Base of FIG. 11a; and

FIG. 12 is a block flow diagram illustrating an exemplary process for making a foam composite of the present invention.

Repeated use of reference characters in the present specification and drawings is intended to represent the same or analogous features or elements of the present invention.

### DEFINITIONS

It should be noted that, when employed in the present disclosure, the terms “comprises,” “comprising” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

The term “absorbent” refers to the ability of a material to provide saturated capacity of at least about 3 grams/gram (g/g) with an aqueous solution containing 0.9 weight percent sodium chloride as measured by the Saturated Capacity Test.

The term “absorbent article” refers to devices which can absorb and contain body fluids, and more specifically, refers to devices which are placed against or near the skin to absorb and contain the various fluids discharged from the body. The term “disposable” is used herein to describe absorbent articles that are not intended to be laundered or otherwise restored or reused as an absorbent article after a single use. Examples of absorbent articles which may or may not be disposable include, but are not limited to, absorbent personal care articles, absorbent health/medical articles, and absorbent household/industrial articles.

The term “active agent” refers to a substance capable of delivering special activity or function to users. Suitable active agents may be in a variety of geometric forms including discrete particles, fibers, flakes, rods, spheres, needles, particles coated with fibers and the like.

The term “additives” refers to constituents or ingredients that are utilized in the making of the thermoplastic foam layer of the present invention.

The term “adhesive” refers to a chemical compound which can provide adhesion to bond the same or different subjects together through a chemical bond and/or a physical association form. The term “hot melt adhesive” refers to a formulation that generally comprises several components. These components typically include one or more polymers to provide cohesive strength (e.g., aliphatic polyolefins such as poly (ethylene-co-propylene) copolymer; ethylene vinyl acetate copolymers; styrene-butadiene or styrene-isoprene block copolymers; and the like); a resin or analogous material (sometimes called a tackifier) to provide adhesive strength (e.g., hydrocarbons distilled from petroleum distillates; rosins and/or rosin esters; terpenes derived, for example, from wood or citrus; and the like); plasticizers or other materials to modify viscosity (i.e., flowability) (examples of such materials include, but are not limited to, mineral oil, polybutene, paraffin oils, ester oils, and the like); and/or other additives including, but not limited to, antioxidants or other stabilizers. A typical hot-melt adhesive formulation might contain from about 15 to about 35 weight percent cohesive strength polymer or polymers; from about 50 to about 65 weight percent resin or other tackifier or tackifiers; from more than zero to about 30 weight percent plasticizer or other viscosity modifier; and optionally less than about 1 weight percent stabilizer or other additive. It should be understood that other adhesive formulations comprising different weight percentages of these components, as well as different components, are possible.

The term “cell” refers to a cavity contained in a foam layer. A cell is closed when the cell membrane surrounding the cavity (i.e., enclosed opening, or cell window) is not perforated and has all membranes intact. Cell connectivity occurs when at least one wall of the cell membrane surrounding the cavity has orifices, or “pores,” that connect to adjacent cells, such that an exchange of fluid is possible between adjacent cells.

The term “compression” refers to the process or result of pressing by applying a force on an object, thereby increasing the density of the object.

The terms “elastomeric,” “elastomer,” “elastic,” and other derivatives of “elastomeric” are used interchangeably and refer to materials having elastomeric or rubbery properties. Elastomeric materials, such as thermoplastic elastomers and thermoplastic vulcanizates, are generally capable of recovering their shape after deformation when the deforming force is removed. Specifically, as used herein, elastomeric is meant to be that property of any material which upon application of an elongating force, permits that material to be stretchable to a stretched length which is at least about 25 percent greater than its relaxed length, and that will cause the material to recover at least 40 percent of its elongation upon release of the stretching elongating force. A hypothetical example which would satisfy this definition of an elastomeric material in the X-Y planar dimensions would be a one (1) inch sample of a material which is elongatable to at least 1.25 inches and which, upon being elongated to 1.25 inches and released, will recover to a length of not more than 1.15 inches. Many elastomeric materials may be stretched by much more than 25 percent of their relaxed length, and can recover to substantially their original relaxed length upon release of the stretching, elongating force. In addition to a material being elastomeric in the described X-Y planar dimensions of a structure, including a web or sheet, the material can be elastomeric in the Z planar dimension. Specifically, when a structure is compressively loaded, it displays elastomeric properties and will essentially recover to its original position upon removal of the load. Compression set is sometimes used to help describe such elastic recovery. When compression is applied to an elastomeric structure, the structure may display elastomeric properties and then recover to near its original position upon relaxation.

The term “extensible” refers to a material that is generally capable of being extended or otherwise deformed, but which does not recover a significant portion of its shape after the extension or deforming force is removed.

The term “flexible” refers to the ability of a material to bend under an imposed load such that its Bending Modulus at 0.5 mm deflection is 1000 g/mm² or lower as measured by the Bending Modulus Test.

The term “foam formula” refers to the base resin and any additives that are combined and used in the foam-making process for the present invention. The term “foam formula mixture” refers to the mixture of components of the foam formula. The term “foam melt” refers to the mixture of components of the foam formula after the mixture has been heated, but prior to cooling and setting of the mixture. The term “base foam layer” and “foam layer” are used interchangeably to refer to the cooled and set mixture from a foam-making process which has been made in accordance with the present invention, but which does not yet contain active agents bonded to at least one surface. In general, the composition of the foam layer is considered to be generally equivalent to the composition of the foam formula.

The term “hydrophilic” describes surfaces which have a high affinity for aqueous liquids and are wetted by the aqueous liquids when in contact with the surfaces. The degree of wetting of the materials can, in turn, be described in terms of the contact angles and the surface tensions of the liquids and materials involved. Equipment and techniques suitable for measuring the wettability of materials can be provided by a CAHN SFA-222 Surface Force Analyzer System available from Thermo Electron Corporation, a business having offices located in Madison, Wis., U.S.A., or a substantially equivalent system. When measured with this system, surfaces having contact angles of less than 90° with water are designated “wettable” or hydrophilic, while surfaces having contact angles greater than 90° with water are designated “nonwettable” or hydrophobic.

The term “household/industrial articles” include construction and packaging supplies, products for cleaning and disinfecting, wipes, covers, filters, towels, disposable cutting sheets, bath tissue, facial tissue, nonwoven roll goods, home-comfort products including pillows, pads, mats, cushions, masks and body care products such as products used to cleanse or treat the skin, laboratory coats, cover-alls, trash bags, stain removers, topical compositions, laundry soil/ink absorbers, detergent agglomerators, lipophilic fluid separators, insulation, packaging, house wrap, cable wrap and the like.

The term “medical article” includes a variety of professional and consumer health-care products including, but not limited to, products for applying hot or cold therapy, hospital gowns, surgical drapes, bandages, wound dressings, covers, containers, filters, disposable garments and bed pads, medical absorbent garments, gowns, underpads, wipes, and the like.

The terms “meltblown fabric” and “meltblown web(s)” refer to substrates comprising fibers formed by extruding a molten thermoplastic material through a plurality of fine, usually circular, die capillaries as molten threads or filaments into converging high velocity gas (e.g., air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin et al., which is hereby incorporated by reference in a manner that is consistent herewith. Meltblown fibers are microfibers which may be continuous or discontinuous, are generally smaller than about 0.6 denier, and are generally self-bonding when deposited onto a collecting surface. Meltblown fibers are sufficiently mobile as described in U.S. Pat. No. 4,950,531 to Radwanski et al. (which is incorporated herein by reference in a manner that is consistent herewith) to allow fiber embedment into a base foam structure with mechanical needling or hydraulic jet treating.

The term “nonwoven” and “nonwoven web” refer to materials and webs of material having a structure of individual fibers or filaments which are interlaid, but not in an identifiable manner as in a knitted fabric. The terms “fiber” and “filament” are used herein interchangeably. Nonwoven fabrics or webs have been formed from many processes such as, for example, meltblown processes, spunbond processes, air laying processes, and bonded-carded-web processes. The basis weight of nonwoven fabrics is usually expressed in ounces of material per square yard (osy) or grams per square meter (gsm) and the fiber diameters are usually expressed in microns. (Note that to convert from osy to gsm, multiply osy by 33.91.)

The term “open-cell” refers to any cell in a foam layer that has at least one broken or missing cell membrane or an orifice in a cell membrane such that it is in communication with a neighboring cell. The term “open-cell foam” refers to a foam wherein 50% or more of the cells are open-cell.

The term “personal care article” includes, but is not limited to, absorbent articles such as disposable diapers, baby wipes, training pants, child-care pants, and other disposable garments; feminine-care products including sanitary napkins, wipes, menstrual pads, panty liners, panty shields, interlabial products, tampons, and tampon applicators; adult-care products including wipes, pads, containers, incontinence products, and urinary shields; and the like.

The term “polymer” generally includes but is not limited to, homopolymers, copolymers, including block, graft, random and alternating copolymers, terpolymers, etc., and blends and modifications thereof. Furthermore, unless otherwise specifically limited, the term “polymer” shall include all possible molecular geometrical configurations of the material. These configurations include, but are not limited to isotactic, syndiotactic, and atactic symmetries.

The term “spunbond” or “spunbond fiber” refers to small diameter fibers which are formed by extruding molten thermoplastic material as filaments from a plurality of fine capillaries of a spinnerette having a circular or other configuration, with the diameter of the extruded filaments then being rapidly reduced, such as taught, for example, in U.S. Pat. No. 4,340,563 to Appel et al.; U.S. Pat. No. 3,692,618 to Dorschner et al.; U.S. Pat. No. 3,802,817 to Matsuki et al.; U.S. Pat. No. 3,338,992 to Kinney; U.S. Pat. No. 3,341,394 to Kinney; U.S. Pat. No. 3,502,763 to Harfmann; U.S. Pat. No. 3,502,538 to Petersen; and U.S. Pat. No. 3,542,615 to Dobo et al., all of which are hereby incorporated by reference in a manner that is consistent herewith. Spunbond fibers are quenched and generally not tacky when they are deposited onto a collecting surface to form a nonwoven web. Spunbond fibers are generally continuous and often have average deniers larger than about 0.3 denier, more particularly, between about 0.6 and 10 denier. In U.S. Pat. No. 5,547,746 to Burton et al. (which is incorporated herein by reference in a manner that is consistent herewith) there is described small denier spunbond fibers that can be embedded into base foam structures with mechanical needling or hydraulic jet treating.

The term “staple fibers” means filaments or fibers which are natural or which are cut from a manufactured filament prior to forming into a web, and which have a length ranging from about 0.1-15 cm, more commonly about 0.2-7 cm.

The term “surfactant” refers to a compound, such as a detergent or wetting agent, that affects the surface tension of fluids.

The term “thermoplastic” describes a material that softens and/or flows when exposed to heat and which substantially returns to its original hardened condition when cooled to room temperature.

The term “viscous fluid” refers to a fluid having a viscosity greater than the viscosity of water, including but not limited to such fluids as menses, menses simulant, fecal fluid, fecal fluid simulant, motor oil, paint, food condiments and the like.

These terms may be defined with additional language in the remaining portions of the specification.

### DETAILED DESCRIPTION

The present invention concerns foam composites. More particularly, the present invention pertains to a thermoplastic foam composite comprising at least one active agent layer including active agent materials coated with a thermal-sticky polymer wherein the layer is bonded to at least one surface of a soft, flexible, absorbent thermoplastic foam layer. The result is a thermoplastic foam composite which can exhibit desirable active agent properties, while maintaining sufficient integrity, absorbency, and/or flexibility for specific applications. In some aspects, a thermoplastic elastomer can be utilized to enhance softness, flexibility and elasticity. In other aspects, a plasticizing agent and/or surfactant can be utilized to improve absorbent properties and open-cell content. In still other aspects, an adhesive can be utilized to assist with bonding the active agent layer to the thermoplastic foam layer. The thermoplastic foam composite of the present invention can be utilized as an article, such as a packaging, wiper, towel, or insulation product, or can be incorporated as a component into a variety of other articles, including personal care articles, health/medical articles, and household/industrial articles, for example.

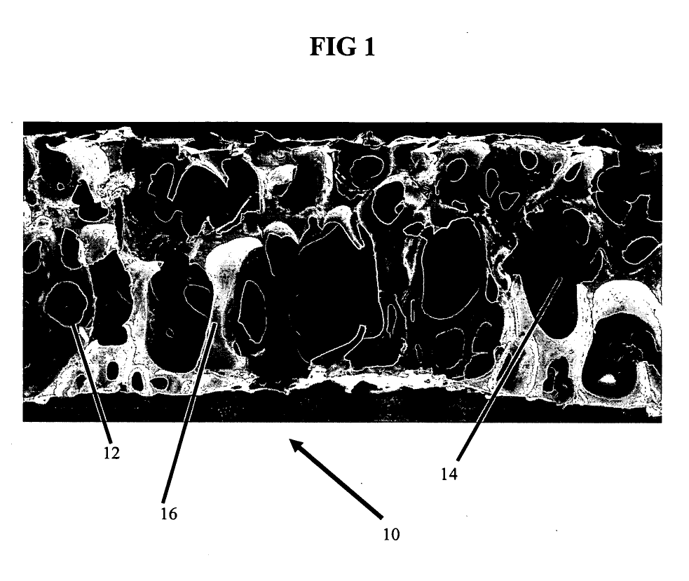

With reference to FIG. 1 of the drawings, there is schematically illustrated a thermoplastic foam layer 10 according to one aspect of the present invention. The foam layer 10 may define a plurality of open-cells 12 which are separated from one another by cell membranes 14 and struts 16. The walls of the cells 12 can be formed from a substantially non-absorbent material. A layer of active agent materials (not shown) are bonded onto at least one surface of the foam 10 such that the active agents are not fully encapsulated by the cell membranes 14 and struts 16 of the foam layer 10.

The thermoplastic foam layer 10 can be hydrophilic and can contain a sufficient continuum of connecting cells with cell sizes that are small enough to generate sufficient capillary forces to draw and contain fluid. To further facilitate fluid management, cell size gradients in the X, and/or Y and/or Z dimensions can also be incorporated. Suitable cell sizes may be in the range of about 5 microns to about 1000 microns, as measured by ASTM D 3576. In some aspects, the thermoplastic foam layer can have foam cell sizes in the range of about 10 microns to about 500 microns, such as about 20 microns to about 300 microns. In other aspects, the thermoplastic foam layer can have foam cell sizes in the range of about 300 microns to about 1000 microns, such as about 500 to about 800 microns. In the case of absorbent foams, relatively smaller cell diameters are more suitable for higher capillary fluid movement (e.g., wicking), whereas relatively larger cell diameters are more suitable for faster fluid intake.

Various other properties of the foam composite can be manipulated during the formation process and/or post-formation treatment of the foam layer such that the foam composite can perform optimally for specific applications. For example, cell membrane pores, which are small orifices in the cell membranes that connect neighboring cells within the foam structure, should be of sufficient number and size to minimize viscous drag and flow resistance to produce effective fluid transport and containment when used for absorbent applications. The specific number and size of the cell membrane pores can be determined by the foam formula (defined above), as well as the processing parameters selected.

The foam composite can provide desirable properties depending upon the application for which it is utilized. In general, a low foam density and low bending modulus are suitable for enhancing absorbency, softness, flexibility, handfeel, tactile and fit aesthetics for absorbent applications such as diapers, feminine care, and incontinence products. For example, in some aspects, the foam can have a bending modulus of about 500 g_{f}/mm² or less, such as about 50 to about 300 g_{f}/mm², as measured by the Bending Modulus Test. In one example, the thermoplastic foam had a bending modulus of 101.5 g_{f}/mm². In another example, the thermoplastic foam had a bending modulus of 73.6 g_{f}/mm².

The foam composite can additionally be extensible or elastic, and can have a low compression set. For example, in some aspects, the foam composite can have an elasticity of about 80% elongation using about 50 grams of force per one inch width of foam. The foam composite can also have desired compression set behavior. For example, in some aspects, the foam composite can have a compression set of less than about 50%, such as less than about 20% as measured by ASTM D 3575.

The foam composite can also have desired mechanical strength properties. For example, in some aspects, the foam composite can have a breaking force of greater than 1000 grams as measured by the Grab Test described in ASTM D 5034.

The foam layer of the present invention generally comprises an open-cell structure. In some aspects, the foam layer can have an open-cell content of about 50% or greater, such as about 70% or greater, or 80% or greater, such as about 50% to about 95% or about 50% to about 85%, as measured using a gas pycnometer according to ASTM D 2856, Method C. Additionally, the foam layer may have about 5% or more closed cells, or about 10% or more closed cells, or about 15% or more closed cells to improve properties such as resiliency and/or compression resistance.

The thermoplastic foam layer can also have desirable densities. For example, the density of such foams can suitably be in the range of about 0.01 g/cc to about 0.5 g/cc, or about 0.03 g/cc to about 0.4 g/cc, or about 0.05 g/cc to about 0.25 g/cc. Furthermore, densification of the foam at some point after the formation process can be employed to enhance functionality for specific applications.

The thermoplastic foam layer can also have desirable basis weights and bulks. For example, in some aspects, the foam can have a basis weight of about 300 gsm or less. In other aspects, the foam can have a bulk, which may or may not be pre-densified, of about 4 mm or less when measured under a load of 0.2 psi, such as when designed for personal care articles.

The thermoplastic foam composite of the present invention may also have desirable absorbency properties. For example, in some aspects, the foam composite can have a Drop Intake test performance that is less than about 25 seconds, such as less than about 8 seconds, or less than about 2 seconds, or less than about 1 second. In other aspects, the foam can have a saturated capacity of about 3 grams/gram (g/g) or greater as measured under a 0.5 psi loading according to the Saturated Capacity Test. In one particular feature, the foam composite has a saturated capacity of about 15 g/g. In another particular feature, the foam composite has a saturated capacity of about 20 g/g.

In still other aspects, the foam composite can have a viscous fluid saturation capacity of about 3 g/g or greater and/or a retention capacity of about 1 g/g or greater, as measured by the Viscous Fluid Saturated Capacity and Centrifuge Retention Capacity Test, respectively. In one particular feature, the foam composite has a retention capacity of about 10 g/g as measured by the Centrifuge Retention Capacity Test. In another particular feature, the foam composite has a retention capacity of about 18 g/g.

The thermoplastic foam layer of the present invention is made of at least one thermoplastic polymer that can be heated, formed, and cooled repeatedly. The starting material used in the foam formula can include at least one suitable base resin which could include a single thermoplastic polymer, a blend of thermoplastic polymers, or a blend of thermoplastic and non-thermoplastic polymers, provided that the foam layer remains substantially thermoplastic. Examples of base resins suitable for use in the foam formula include styrene polymers, such as polystyrene or polystyrene copolymers or other alkenyl aromatic polymers; polyolefins including homo or copolymers of olefins, such as polyethylene, polypropylene, polybutylene, etc.; and polyesters, such as polyalkylene terephthalate; and combinations thereof. For example, in some aspects, a suitable base resin includes STYRON 685D polystyrene resin, available from Dow Chemical Company, a business having offices located in Freeport, Tex., U.S.A.

Coagents and compatibilizers can also be utilized for blending such resins. Additionally, crosslinking agents can be employed to enhance mechanical properties, foamability and expansion. Such crosslinking may be accomplished by utilizing several means, including the use of electron beams or by chemical crosslinking agents such as organic peroxides.

It is suitable to utilize base resins which provide effective foamability, softness, and flexibility. In general, resins having branched polymer chains tend to be more foamable. As such, flexibility, softness, and foamability can be manipulated by utilizing several means, including the use of polymer side groups; the incorporation of chains within the polymer structure to prevent polymer crystallization; the lowering of the glass transition temperature; the lowering of a given polymer's molecular weight distribution; the adjusting of melt flow strength and viscous/elastic properties including elongational viscosity of the polymer melt; the use of block copolymerization; the blending of polymers; the use of polyolefin homopolymers and copolymers, including low (such as linear low), medium and high-density polyethylene and polypropylene which are normally made using Ziegler-Natta or Phillips catalysts and are relatively linear, as well as those that can be engineered with elastic and crystalline areas; the use of syndiotactic, atactic, and isotactic polypropylenes including those made using metallocene-based catalysts, as well as blends of such and other polymers; and the use of olefin elastomers.

In some applications, it is suitable to utilize resins which provide foam composites that are soft and extensible. Softness and extensibility can be manipulated using several means, including the use of ethylene and α-olefin copolymers, particularly those made using either Ziegler-Natta or a metallocene catalyst such as metallocene catalyzed polyolefins; the use of polyethylene cross-linked with α-olefins and various ethylene ionomer resins; and the use of ethyl-vinyl acetate copolymers with other polyolefin-type resins.

Common modifiers for various polymers can also be reacted with chain groups to obtain suitable functionality. This includes the use of alkenyl aromatic polymers and ionomer resins. Suitable alkenyl aromatic polymers include alkenyl aromatic homopolymers, copolymers of alkenyl, aromatic compounds, copolymerizable ethylenically unsaturated comonomers including minor proportions of non-alkenyl aromatic polymers, and blends thereof.

Thermoplastic base resins of the present invention may also contain blends of other polymers with the thermoplastic polymers, provided that the resulting foam remains thermoplastic. Such other polymers can include natural and synthetic organic polymers such as cellulosic polymers, methyl cellulose, polylactic acids, polyvinyl acids, polyacrylates, polycarbonates, starch-based polymers, polyetherimides, polyamides, polymethylmethacrylates, and copolymer/polymer blends.

In addition to the base resin polymers discussed above, the foam formula can optionally include at least one thermoplastic elastomer. For, example, in some aspects, the foam formula can comprise at least about 5% by weight of thermoplastic elastomer, such as about 5% to about 50%, or about 20% to about 50% by weight of thermoplastic elastomer. In another aspect, the foam formula can comprise substantially equal amounts of base resin and thermoplastic elastomer.

Suitable thermoplastic elastomers include, but are not limited to, rubbers, including natural rubber, styrene-butadiene rubber (SBR), polybutadiene, ethylene propylene terpolymers, and vulcanized rubbers, including TPVs; rubber-modified polymers such as styrene elastomers;

ethylene elastomers; butadiene; polybutylene resins; diblock, triblock, tetrablock, or other multi-block thermoplastic elastomers; and/or flexible copolymers such as polyolefin-based thermoplastic elastomers including random block copolymers including ethylene α-olefin copolymers; block copolymers including hydrogenated butadiene-isoprene-butadiene block copolymers; stereoblock polypropylenes; graft copolymers, including ethylene-propylene-diene terpolymer or ethylene-propylene-diene monomer (EPDM), ethylene-propylene random copolymers (EPM), ethylene propylene rubbers (EPR), ethylene vinyl acetate (EVA), and ethylene-methyl acrylate (EMA); and styrenic block copolymers including diblock and triblock copolymers such as styrene-isoprene-styrene (SIS), styrene-butadiene-styrene (SBS), styrene-isoprene-butadiene-styrene (SIBS), styrene-ethylene/butylene-styrene (SEBS), or styrene-ethylene/propylene-styrene (SEPS).

Suitable thermoplastic elastomers include KRATON (such as blend G 2755), a thermoplastic elastomer available from Kraton Polymers, a business having offices located in Houston, Tex., U.S.A.; VECTOR SIS and SBS thermoplastic elastomers available from Dexco, a division of ExxonMobil Chemical Company, a business having offices located in Houston, Tex., U.S.A.; and SEPTON SEBS thermoplastic elastomer, available from Kuraray America, Inc., a business having offices located in New York City, N.Y., U.S.A.

Additional suitable thermoplastic elastomers include blends of thermoplastic elastomers with dynamic vulcanized elastomer-thermoplastic blends; thermoplastic polyether-ester elastomers; ionomeric thermoplastic elastomers; thermoplastic elastic polyurethanes such as LYCRA polyurethane, available from Invista, a business having offices located in Wichita, Kans., U.S.A., and ESTANE available from Noveon, Inc., a business having offices located in Cleveland, Ohio, U.S.A.; thermoplastic elastic polyamides, including polyether block amides such as PEBAX polyether block amide available from Atofina Chemicals, Inc., a business having offices located in Philadelphia, Pa., U.S.A.; thermoplastic elastic polyesters such as HYTREL available from Invista; and ARNITEL available from DSM Engineering Plastics, a business having offices located in Evansville, Ind., U.S.A.; and single-site or metallocene-catalyzed polyolefins having a density of less than about 0.89 grams/cubic centimeter, such as AFFINITY metallocene polyethylene resins available from Dow Chemical Company; and combinations thereof.

As used herein, a tri-block copolymer has an ABA structure where the A represents several repeat units of type A, and B represents several repeat units of type B. As mentioned above, several examples of styrenic block copolymers are: SBS, SIS, SIBS, SEBS, and SEPS. In these copolymers the A blocks are polystyrene and the B blocks are the rubbery component. Generally these triblock copolymers have molecular weights that can vary from the low thousands to hundreds of thousands and the styrene content can range from 5% to 75% as based on the weight of the triblock copolymer. A diblock copolymer is similar to the triblock but is of an AB structure. Suitable diblocks include styrene-isoprene diblocks which have a molecular weight of approximately one-half of the triblock molecular weight and have the same ratio of A blocks to B blocks. Diblocks with a different ratio of A to B blocks or a molecular weight larger or greater than one-half of triblock copolymers may be suitable for improving the foam formula for producing low-density, soft, flexible, and/or absorbent foam utilizing polymer extrusion.

It may be particularly beneficial to include a thermoplastic elastomer having a high diblock content and high molecular weight as part of the foam formula to extrude a low-density, soft, flexible, resilient, and/or absorbent thermoplastic foam. For example, the thermoplastic elastomer may have a diblock content between about 50% and about 80% by weight of the total thermoplastic elastomer weight.

Additionally, KRATON thermoplastic elastomers can function as a discontinuous phase in styrenic-based foams and further function as cell-opening generators when used in small amounts. However, in larger amounts, the cell-opening effect may be somewhat secondary compared to the resiliency, flexibility, elasticity, and softness imparted.

In addition to the constituents discussed above, the foam formula can also include at least one plasticizing agent. A plasticizing agent is a chemical agent that can impart flexibility, stretchability and workability. The type of plasticizing agent utilized has an influence on foam gel properties, blowing agent migration resistance, cellular structure, including the fine cell size, and the number of open cells. Typically, plasticizing agents are of low molecular weight. The increase in polymer chain mobility and free volume caused by incorporation of a plasticizing agent typically results in a glass transition temperature (Tg) decrease (plasticizing agent effectiveness is often characterized by this measurement.) For example, petroleum-based oils, fatty acids, and esters are commonly used and act as external plasticizing agents or solvents because they do not chemically bond to the polymer yet remain intact in the polymer matrix upon crystallization.

Plasticizing agents are sometimes used as cell openers in producing foams. When used as cell openers,.these plasticizing agents are added to the thermoplastic foam formula in minor amounts, such as described in U.S. Pat. No. 6,071,580 which is incorporated herein by reference in a manner that is consistent herewith. More particularly, the plasticizing agent can act to increase cell expansion to produce a high expansion ratio. In addition, when the thermoplastic polymer cools and when volumetric contraction with crystallization occurs, thin portions of the cell membranes can rupture such as to create additional connections, or pores, between cells; thus, the plasticizing agent increases open-cell content. Suitably, the plasticizing agent is included in an amount between about 0.5% and about 10%, or between about 1% and about 10%, by weight, of the foam formula. The plasticizing agent is gradually and carefully metered in increasing concentration into the foam formula mixture during the foaming process because excess plasticizing agent can create cellular instability, resulting in cellular collapse.

Although plasticizing agents can function as softeners, the addition of plasticizing agents often makes foaming to low densities difficult. In particular, plasticizing agents typically lower polymer melt viscosities and lead to increasing melt drainage that causes foaming difficulties with cell collapse. In fact, in certain manufacturing processes, such as food packaging processes, plasticizing agents can be used as defoaming agents.

Examples of suitable plasticizing agents include polyethylene, ethylene vinyl acetate, mineral oil, palm oil, waxes, esters based on alcohols and organic acids, naphthalene oil, paraffin oil, and combinations thereof. A commercially available example of a suitable plasticizing agent is a small-chain polyethylene that is produced as a catalytic polymerization of ethylene; because of its low molecular weight it is often referred to as a “wax.” This low-density, highly branched polyethylene “wax” is available under the trade designation EPOLENE C-10 from Eastman Chemical Company, a business having offices located in Kingsport, Tenn., U.S.A.

The criterion for selecting a plasticizing agent for personal care articles includes a wide range of properties including not only its softening ability but also temperature stability upon extrusion, resistance to migration, cost, odor, biodegradability, and manufacturing and consumer safety. In order for the foam to be used in personal care and medical articles applications and many absorbent wiping articles and non-personal care articles, the foam may also meet stringent chemical and safety guidelines. A number of plasticizing agents are FDA-approved. These plasticizing agents include: acetyl tributyl citrate; acetyl triethyl citrate; p-tert-butylphenyl salicylate; butyl stearate; butylphthalyl butyl glycolate; dibutyl sebacate; di-(2-ethylhexyl) phthalate; diethyl phthalate; diisobutyl adipate; diisooctyl phthalate; diphenyl-2-ethylhexyl phosphate; epoxidized soybean oil; ethylphthalyl ethyl glycolate; glycerol monooleate; monoisopropyl citrate; mono-, di-, and tristearyl citrate; triacetin (glycerol triacetate); triethyl citrate; and 3-(2-xenoyl)-1,2-epoxypropane.

In addition to the additives discussed above, the foam formula can also include at least one blowing agent additive to aid in the foaming process and to help form a foamable melt. Both physical and chemical blowing agents, including both inorganic and organic physical blowing agents, can be used to create or enhance foaming. Chemical blowing agents, which are compounds that decompose at extrusion temperatures to release large volumes of gas; volatile liquids such as refrigerants and hydrocarbons; ambient gases such as nitrogen and carbon dioxide; water; or combinations thereof can also be employed.

Suitable inorganic physical blowing agents include water, nitrogen, carbon dioxide, air, argon, and helium. Suitable organic blowing agents include hydrocarbons such as methane, ethane, propane, butanes, pentanes, hexanes, and the like. Aliphatic alcohols and halogenated hydrocarbons, including various FREON and fluorocarbons such as R-134A, can also be used (although their use may be avoided for environmental reasons). Endothermic and exothermic chemical blowing agents which are typically added at the extruder hopper include: azodicarbonamide, paratoluene sulfonyl hydrazide, azodiisobutyro-nitrile, benzene sulfonyl hydrazide, P-toluene sulfonyl hydrazide, barium azodicarboxylate, sodium bicarbonate, sodium carbonate, ammonium carbonate, citric acid, toluene sulfonyl semicarbazide, dinitroso-pentamethylene-tetramine, phenyltetrazole sodium borohydride, and the like.

In addition, mixtures and combinations of various physical and chemical blowing agents can be used to control cell structure. Blowing agent activators can also be added to lower the decomposition temperature/profile of such chemical blowing agents. Such blowing agent activators include metals in the form of salts, oxides, or organometallic complexes.

Blowing agents can be added directly to the foam formula or, alternatively, can be added after the melt temperature has been heated to a temperature at or above its glass transition temperature or melting temperature. The inlet for a blowing agent, such as in an extrusion process, is typically between the metering and mixing zones. The blowing agent is mixed thoroughly with the melted polymer at a sufficiently elevated pressure to prevent melt expansion. In some aspects, a blowing agent can be added to the foam formula in an amount between about 1% and about 10% by weight.

Other additives can also be included in the foam formula to enhance various properties. For example, a nucleating agent, or nucleant, can be utilized to improve foam gas bubble formation and to obtain desired fine open-cell structure. Examples of suitable nucleants include talc, magnesium carbonate, nanoclay, silica, calcium carbonate, blends of citric acid and sodium bicarbonate, coated citric acid/sodium bicarbonate particles, silica, barium stearate, diatomaceous earth, titanium dioxide, pulverized wood, clay, calcium stearate, stearic acid, salicylic acid, fatty acids, metal oxides, modified nucleant complexes, and combinations thereof; An example of a commercially available nucleant is a nanoclay under the trade name CLOISITE 20A, available from Southern Clay Products, Inc., a business having offices located in Gonzales, Tex., U.S.A. Various thermoplastic polymers may also be used for such purposes.

Nucleants are typically dry blended or added with the polymer concentrate. The amount of nucleant will vary based upon several parameters, including the cell structure desired, foaming temperature, pressure, polymer composition, and type of nucleating agent utilized. For example, in some aspects, a nucleant can be added to the foam formula in an amount between about 0.1% and about 5% by weight. Typically, as the amount of nucleant increases, the cell density likewise increases.

Still other additives that can be utilized with the invention include surface active agents (i.e., surfactants). Surfactants may be utilized to control properties such as surface tension, foam formation, and wettability.

Suitable surfactants for the absorbent composite can be single-component or multi-component surfactants. A multi-component surfactant is a combination of two or more surfactants. It has been found that certain multi-component surfactants can achieve equal or better foam formation at a lower dosage than certain single-component surfactants. For example, in some aspects, foams utilizing a multi-component surfactant have densities comparable to foams made with over three times the amount of a single-component surfactant. Since surfactant tends to be a costly additive, the use of certain multi-component surfactants can result in foam composites having comparable foam properties at a lower cost than foams which include higher amounts of single-component surfactant.

Surfactants can be added at various locations in the foam-making process, such as directly in the foam formula, in the composition during the foaming process, and/or as a post-formation treatment after formation of the foam composite. In one aspect, for example, the surfactant can be added to the foam melt in a gaseous phase, such as through the use of a blowing agent, such as supercritical carbon dioxide.

Other examples of suitable surfactants include cationic, anionic (including alkylsulfonates), amphoteric, and nonionic surfactants. Exemplary surfactants include SCHERCOPOL OMS-NA, a disodium monooleamido MEA sulfosuccinate, available from Scher Chemicals, Inc., a business having offices located in Clifton, N.J., U.S.A., and PLURONIC F68, a polypropylene glycol non-ionic surfactant which is a block copolymer of propylene oxide and ethylene oxide, available from BASF Corporation, a business having offices located in Florham Park, N.J., U.S.A. Other examples include HOSTASTAT HS-1, available from Clariant Corporation, a business having offices located in Winchester, Va., U.S.A.; EMEREST 2650, EMEREST 2648, and EMEREST 3712, each available from Cognis Corporation, a business having offices located in Cincinnati, Ohio, U.S.A.; and DOW CORNING 193, available from Dow Corning Corporation, a business having offices located in Midland, Mich., U.S.A. Alkyl sulfonates can also be suitable as a surfactant (although use of this class of surfactants in certain applications may be limited because of product safety concerns.) However, some combinations of surfactants offer benefits where an alkyl sulfonate is added at a substantially lower level in conjunction with another surfactant(s) to yield good foaming and wettability.

The amount of surfactant utilized will vary depending upon the particular surfactant, as well as the properties desired. For example, in some aspects of the invention, the surfactant can be utilized in the foam formula in an amount between about 0.05% and about 10% by weight, such as between about 0.1% and about 5% by weight.

In addition to the additives discussed above, the thermoplastic foam of the present invention can also comprise fiber. Such fiber can, among other things, promote distribution and storage of fluids within the foam layer, as well as enhance overall surface energy for fluid uptake. The fiber can additionally improve the integrity and resiliency of the foam composite. Such fibers can be added as part of the foam formula and/or may be added through a post-formation means.

The total fiber content in the final foam composite can be between about 0% and about 90% by weight of fiber with respect to the foam composite, such as between about 5% and about 50% by weight, or between about 10% and about 30% by weight. Suitable fibers can be hydrophilic, hydrophobic, or a combination thereof. In some aspects, these fibers can be high surface energy fibers. The fibers may comprise synthetic fibers, including meltblown, spunbond, and staple fibers, natural fibers, bicomponent fibers, or continuous filaments having various deniers and lengths. For example, natural fibers include silk, cotton, vegetable fibers, wood, and other cellulosic fibers; semi-synthetic fibers include acetate and premix; and synthetic fibers include polyethylene terephthalate (PET), rayon, nylon, modified hydrophilic polyolefins and hollow fibers, vinylon, vinylidene, vinyl chloride, polyester, acryl, polyethylene, polypropylene, and polyurethane fibers. Polymeric pulp fibers may also be used, although these tend to be less wettable than high surface energy cellulosic fibers. Blends of such fibers can also be suitable for the foam of the present invention. Mixtures of these fibers may also be used. For example, the fibrous component of the foam composite may contain from about 5% to about 50% by weight of synthetic fibers and from about 50% to 95% by weight of cellulosic fibers.

In some aspects, the fibers utilized in the foam composite of the present invention can extend through at least one cell to connect to another cell, and desirably through multiple cells, thus reducing the tortuous fluid path that may otherwise exist in the foam cells. In some aspects, fine long fibers such as those with a fiber length greater than about 5 mm, including rayon and cotton, can be used to obtain desirable properties, such as enhanced fluid movement during wicking. In other aspects, fibers with a length of about 0.5 mm to about 5 mm, such as in the range of about 2 mm to about 5 mm (e.g., softwood fibers), can be used to provide a foam composite with an alternate balance of hydrophilic surface and resistance to fluid flow, which can result in faster intake while maintaining sufficient wicking. In still other aspects, short fibers in the range of 0.5 mm to about 2 mm (e.g. hardwood fibers, including Eucalyptus fibers) can be used to provide a high hydrophilic surface area for liquid transport and improved capillarity.

Various other additives such as lubricants, acid scavengers, stabilizers, colorants, adhesive promoters, fillers, smart-chemicals, foam regulators, various UV/infrared radiation stabilizing agents, antioxidants, flame retardants, smoke suppressants, anti-shrinking agents, thermal stabilizers, anti-statics, permeability modifiers, and other processing and extrusion aids including mold release agents, anti-blocking agents, and the like can also be included in the foam formula.

Once the desired ingredients of the foam formula have been determined, the materials can be added together and prepared to be formed in a foam-making process. The base foam layer can be made from foam-making processes known in the art. For example, in some aspects, various continuous plastic extrusion processes known in the art can be utilized to produce the foam layer. Other suitable foam making processes known in the art include injection molding, batch processes, and frothing processes.

In general, the materials can be heated such that the materials form a molten foam melt, at which time the materials can form a substantially homogeneous mixture. In some aspects, the materials are suitably heated to a temperature between about 100 and about 500 degrees Celsius to create the foam melt. Such foam melt can then be foamed to create cells within the melt using suitable foaming techniques known to those skilled in the art. Once formed, the foam melt can then be processed, such as with an extrusion process, and cooled to form the foam composite.

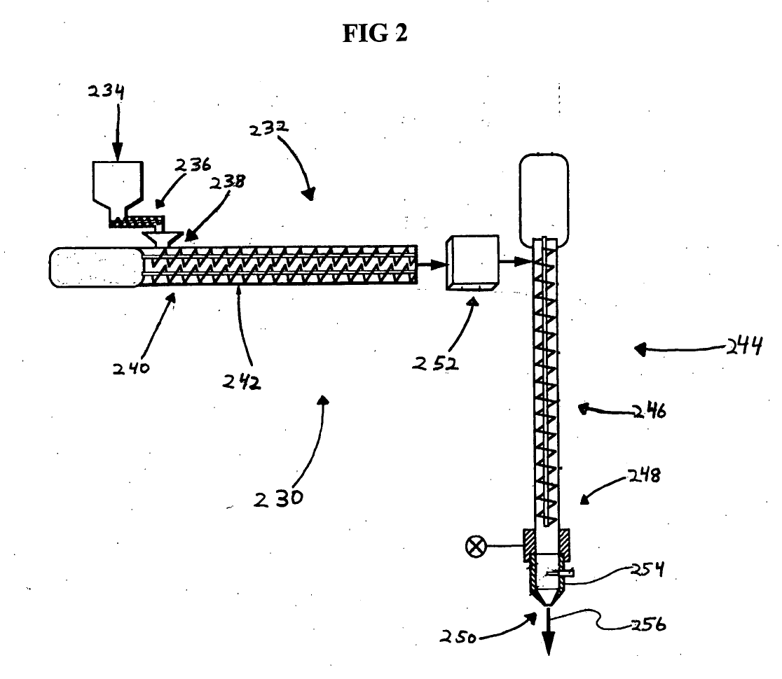

In some aspects, continuous plastic extrusion processes known in the art can be utilized to produce the foam composite. In the case of such extrusion processes, a tandem screw-type extruder, such as illustrated in FIG. 2, can be utilized. This type of extruder 230 may be considered particularly suitable in some aspects because it has the ability to provide tight control of extrusion temperatures to produce open-cell foam. With tandem extruders 230, the first extruder section 232 typically contains several zones including a feed zone 234, a conveying zone 236, a compression zone 238, a melting zone 240, and a metering and mixing zone 242. The second extruder section 244 often contains a cooling zone 246 and a shaping zone 248 prior to the discharge 250. The first extruder 232 is typically hopper loaded with the base resin(s) as well as any other desired additives, including thermoplastic elastomers, plasticizing agents, surfactants and/or fibers, for example. Techniques known in the art for accomplishing this include using dry blend/metering equipment and/or having the components incorporated into a pelletized polymer concentrate such as in a masterbatch. The components of the foam formula are then heated in the extruder 232 to form a plasticized or melt polymer.

The foamable melt is then typically cooled to a lower temperature to control the desired foam, cell structure. In the case of tandem extruders 230, the cooling is typically accomplished in the second extruder 244 which is connected downstream of the first extruder 232 through a heated cross-over supply pipe 252. In the case of single extruders (not shown), cooling is typically accomplished upstream of the discharge orifice. Often cooling/heating systems with process temperature control loops are incorporated to tightly control foam bubble nucleation/growth within the gas-laden melt. The optimum cooling temperature for foam formation is typically at or slightly above the glass transition temperature or melting point of the melt.

The melt is then extruded through a die 254 to a lower pressure (typically atmospheric or a vacuum) and lower temperature (typically ambient) environment to cause thermodynamic instability and foaming which then cools and crystallizes the plastic to form a stabilized foam 256 which then solidifies to form a web or layer. Often circular, annular or slit dies, including curtain dies, and the like are used, often with a mandrel, to shape and draw the web to the desired gauge, shape, and orientation with foam expansion and cooling.

Various equipment configurations using such extrusion means can be used to manufacture the foam composite of the present invention. In addition, various specialized equipment can be employed upstream of specially designed dies to enhance mixing, cooling, cellular structure, metering, and foaming. Such equipment includes static mixers, gear pumps, and various extruder screw designs, for example. Stretching equipment, including roller nips, tenters and belts may also be used immediately downstream of the discharge to elongate cellular shape to enhance absorbency, for example. Microwave irradiation for cross-linking, foaming activation and mechanical means can also be used to enhance foam properties. Foam contouring, shaping (e.g. use of a wire mesh pattern) and the like, using thermoforming, and other such thermal processes, including thermal bonding, can be used to control shaping, flexibility, softness, aesthetics, and absorbent swelling.

Open-cell formation can be regulated by elevated processing pressures and/or temperatures, as well as by using additives such as nucleating agents, chemical blowing agents, and low additions of immiscible polymers, and/or surfactants which can control both cell density and cell structure. Particular base resins are also sometimes used to broaden the foaming temperature to make open-cell foam. For example, the open-cell level of a polystyrenic-based foam can be facilitated by adding small amounts of various immiscible polymers to the foam formula, such as by adding polyethylene or ethylene/vinyl acetate copolymer, to create interphase domains that cause cell wall rupture. In another aspect, ethylene-styrene interpolymers can be added to alkenyl aromatic polymers to control open-cell quality, and to improve surface quality and processability. In still another aspect, small amounts of polystyrene-based polymers can be added to polyolefin-based foams to increase open-cell content. The open-cell content and microporous cell membrane uniformity can also be controlled by regulating the polymer components and crystallization initiating temperature.

Post-formation treatments, can be performed to improve, among other things, absorbency, cellular orientation, aesthetics, softness and similar properties. This can be accomplished through numerous techniques known in the art including hydraulic jet treating, mechanical needling and other mechanical perforation (such as to soften foam and increase open-cell content), stretching and drawing (such as for cellular orientation and softening), calendaring or creping (such as to soften and rupture cell membranes to improve cellular intercommunication), brushing, scarfing, buffing/sanding, and thermoforming (such as to shape the foam composite). Often a foam surface skin may form during extrusion, which can later be skived or sliced off, needle-punched, jet treated, brushed, scraped, buffed, scarved, sanded or perforated to remove the barrier. Depending on the specific usage of the foam, application of a surfactant after the foaming process or after a post-formation process may further be utilized to afford a desired wettability.

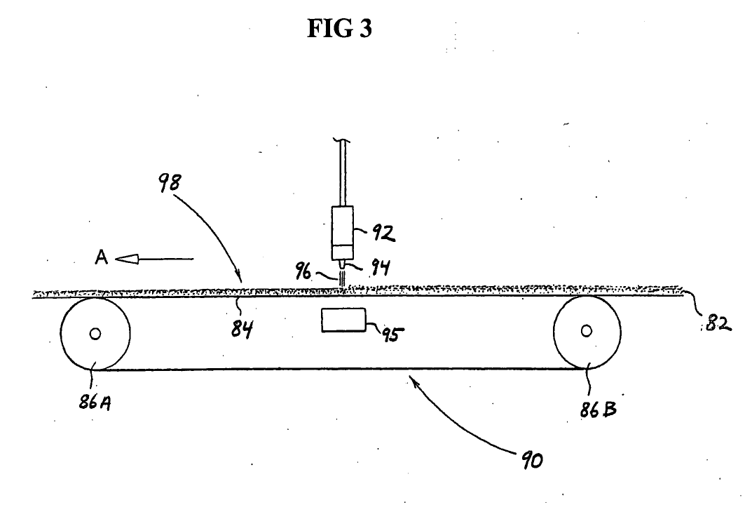

FIG. 3 illustrates one exemplary process for hydraulic jet treating a thermoplastic foam layer. In this example, a foam layer 82 is supported on an apertured foraminous support or carrier belt 84 of a hydraulic jet treating machine 90. The carrier belt 84 is supported on two or more rolls 86A and 86B provided with suitable driving means (not shown) for moving the belt 84. The carrier belt 84 may, for example, be a single plain weave foraminous wire having a mesh size from about 20 to about 150. Alternatively, a perforated plate (not shown) can be utilized as a backing carrier.

The foam layer 82 is then passed under one or more manifolds 92. The hydraulic jet treating process may be carried out with any appropriate working fluid such as, for example, water. The working fluid is generally evenly distributed by the manifold 92 through a series of individual holes or orifices 94 which may be from about 0.003 to about 0.015 inch in diameter. In some aspects, the working fluid passes through the orifices 94 at a pressure generally ranging from about 50 to about 3000 pounds per square inch gage (psig), such as about 60 to about 1500 psig or about 100 to about 800 psig, or even about 200 to about 600 psig. In general, thermoplastic foam layers may utilize a fluid pressure ranging from about 60 to about 400 psig, when one to four manifolds are used. However, greater hydraulic jet treating energy may also be desired or required for high basis weight materials, stiffer modulus, higher line speeds, and the like.

Water jet treatment equipment and other hydraulic jet treating equipment and processes which may be adapted can be found, for example, in U.S. Pat. No. 3,485,706 to Evans, and in an article by Honeycomb Systems, Inc. entitled “Rotary Hydraulic Entanglement of Nonwovens,” reprinted from INSIGHT 86 INTERNATIONAL ADVANCED FORMING/BONDING CONFERENCE, both of which are incorporated herein by reference in a manner consistent herewith. In some aspects, the invention may be practiced using a manifold containing a strip having 0.007 inch diameter orifices, 30 orifices per inch and one row of orifices such as that produced by Metso Paper USA, Inc. a business having offices located in Biddeford, Me., U.S.A. Other manifold configurations and combinations such as those available from Fleissner GmbH, a business having offices in Egelsbach, Germany or Rieter Perfojet S.A., a business having offices located in Winterthur, Switzerland, may also be used. For instance, in some aspects a single manifold may be utilized, whereas in other aspects several manifolds may be arranged in succession.

The resulting columnar jetted streams 96 of the working fluid impact on the foam layer 82, thereby puncturing the skin which may have formed on the foam layer surface during formation, and increasing the open-cell content of the layer. Additionally, vacuum slots in a suction box(es) 95 may be located directly beneath the hydraulic jet manifold(s) 94 and beneath the carrier belt 84 as well as downstream of the hydraulic jet manifold(s) 94 to remove excess water from the hydraulically jet-treated material 98. The hydraulically jet-treated foam layer 98 can then be dried using means known in the art.

Once the foam layer has been provided, at least one layer comprising coated active agent materials can be bonded to a surface of the foam layer. Suitable active agents include, but are not limited to, superabsorbent materials; ion exchange resin particles; skin care compounds (such as moisturizers, emollients); perfumes; natural fibers; synthetic fibers; fluid modifiers; odor control particles; cooling and heating agents; anti-microbial agents; bactericide and fungicide agents; encapsulated particles containing agents in liquid form such as detergent, fatty-acids, ester, proteins, coagulants, pH modifiers; nanoparticles and the like.

Suitable superabsorbent materials are available from various commercial vendors, such as Stockhausen, Inc., BASF Inc. and others. For example, the superabsorbent material can be FAVOR SXM 9394, available from Stockhausen, Inc., a business having offices located in Greensboro, N.C., U.S.A. Suitable ion exchange resin particles include AMBERLITE ion exchange resins including strongly acidic/basic, or weakly acidic/basic types that are available from Aldrich Chemical Company, Inc., a business having offices located in Milwaukee, Wis., U.S.A.

Suitable skin care compounds include emollients, moisturizers, antioxidants, natural antibiotics, proteins and vitamins, collagens, elastins, and the like. Suitable perfumes include mixtures of fragrant essential oils and aroma compounds, fixatives and alcohols. Suitable natural fibers include NB 416, a bleached southern softwood Kraft pulp, available from Weyerhaeuser Co., a business having offices located in Federal Way, Wash. U.S.A.; CR 54, a bleached southern softwood Kraft pulp, available from Bowater Inc., a business having offices located in Greenville, S.C. U.S.A.; and SULPHATATE HJ, a chemically modified hardwood pulp, available from Rayonier Inc., a business having offices located in Jesup, Ga. U.S.A. Suitable synthetic fibers include T-105 KoSa fibers (available from Invista, a business having offices located in Charlotte, N.C., U.S.A.), FYBREL fibers (available from MiniFibers Inc., a business having offices located in Johnson City, Tenn., U.S.A.) and TENCEL fibers (available from Lenzing, a business having offices located in Lenzing, Austria).

Suitable fluid modifiers include precipitants, blood coagulants, liquid thickeners or thinners, demulsifiers, buffer agents, inhibitors and the like. Suitable odor control particles include baking soda powder or activated carbon powder. Suitable cooling agents include any endothermic compounds, such as sodium acetate trihydrate (NaC₂H₃O₂.3H₂O) and potassium nitrate (KNO₃). Suitable heating agents include any exothermic compounds, such as lithium chloride (LiCl) and sodium acetate (NaC₂H₃O₂). Suitable anti-microbial agents (such as bacteriacides, fungicides and the like) include any cationic polymers, such as chitosan, or special surfactants.

Nanoparticles have a particle sizes ranging from 1 to 1000 nanometers. Examples of suitable nanoparticles include titanium dioxide, layered clay minerals, alumina oxide, silicates, and combinations thereof. Other suitable nanoparticles include nano-superabsorbent, nano-complexes for skin care, nanoparticles for odor control, nanoparticles or nanostructures for modifying fluids or as fluid modifiers, nanostructures that create color without dye, nanoparticles that makes automotive finishes more scratch resistant, nanoparticles that provide a lotus effect, and the like.

Additionally, when an active agent is in liquid form, it can be encapsulated to form solid particles used in this invention. Suitable liquid agents for encapsulated particles include detergent, fatty acids, ester, proteins, pH modifiers and the like or any substances described above that are in liquid form.

In one particular feature, the absorbent properties, such as Centrifuge Retention Capacity, can be enhanced by utilizing superabsorbent materials as the active agent. Such superabsorbent materials can be selected from natural, synthetic, and modified natural polymers and materials. The superabsorbent materials can be inorganic materials, such as silica gels, or organic compounds, such as crosslinked polymers. The term “crosslinked” refers to any means for effectively rendering normally water-soluble materials substantially water insoluble, but swellable. Such means can comprise, for example, physical entanglement, crystalline domains, covalent bonds, ionic complexes and associations, hydrophilic associations, such as hydrogen bonding, and hydrophobic associations or Van der Waals forces.

The superabsorbent material may be in a variety of geometric forms. In one example, the superabsorbent material is in the form of discrete particles. However, the superabsorbent material may also be in the form of fibers, flakes, rods, spheres, needles, particles coated with fibers, and the like.

Superabsorbent materials suitable for use in the present invention are known to those skilled in the art. Generally stated, the superabsorbent material can be a water-swellable, generally water-insoluble, hydrogel-forming polymeric absorbent material, which is capable, under the most favorable conditions, of absorbing at least about 10 times its weight, or at least about 15 times its weight, or at least about 25 times its weight in an aqueous solution containing 0.9 weight percent of sodium chloride. The hydrogel-forming polymers are desirably lightly crosslinked to render the material substantially water insoluble. Crosslinking may, for example, be by irradiation or covalent, ionic, Van der Waals, or hydrogen bonding. Mixtures of natural and wholly or partially synthetic absorbent polymers can also be useful. Processes for preparing synthetic, absorbent gelling polymers are disclosed in U.S. Pat. No. 4,076,663 to Masuda et al. and U.S. Pat. No. 4,286,082 to Tsubakimoto et al., each of which is incorporated herein by reference in a manner that is consistent herewith.

The hydrogel-forming polymeric absorbent material may be formed from organic hydrogel-forming polymeric material, which may include natural material such as agar, pectin, alginates, xanthan gum, locust bean gum, guar gum and the like; modified natural materials such as carboxymethyl cellulose, methyl cellulose, carboxyethyl cellulose, chitosan salt, and hydroxypropyl cellulose; and synthetic hydrogel-forming polymers. Synthetic hydrogel-forming polymers include, for example, alkali metal and ammonium salts of polyacrylic acids, polymethacrylic acids, polyacrylamides, alpha-olefins, poly(vinyl pyrolidone), polyvinyl alcohol, maleic anhydride copolymer with vinyl ethers, ethylene maleic anhydride copolymers, polyvinyl ethers, polyvinyl morpholinone, polymers and copolymers of vinyl sulfonic acid, polyacrylates, polyvinyl amines, polyquaternary ammonium, polyacrylamides, polyvinyl pyridine and the like, and mixtures and copolymers thereof. Other suitable hydrogel-forming polymers include hydrolyzed acrylonitrile grafted starch, acrylic acid grafted starch, and isobutylene maleic anhydride copolymers, and mixtures thereof.

Superabsorbent material may be present at a concentration of up to about 95% superabsorbent material by weight, such as about 10% to about 90% by weight, or about 15% to about 85% by weight of the composite. In one particular example, the superabsorbent material comprises about 40% by weight of the thermoplastic foam composite, after performing the Shake-Out Procedure (described below). In another particular example, the superabsorbent material comprises about 70% of the thermoplastic foam composite, after performing the Shake-Out Procedure.

Once the desired active agent materials have been provided, they can further include a distinctive surface treatment material in the form of a thermal-sticky polymer coating. In a particular aspect, the surface treatment can include a polymer that is thermally processable. In another aspect, the surface treatment can include a polymer that is thermally processable and water-soluble. The coating may be discontinuous or substantially continuous, as appropriate for providing an operative surface treatment of the active agents.

Generally stated, the surface treatment material (i.e. the thermal-sticky polymer coating) can desirably have a melt-temperature and/or a softening-temperature which can be greater than the temperature of the means (e.g., air or other gas, conveyor, dispensing bin and the like) that carries the active agents to the desired foam layer surfaces. The coating polymer can desirably provide an operative amount of stickiness at temperatures near or above the melting-point or softening-point of the coating polymer. In a desired feature, the thermal-sticky polymer can have a thermal-sticky polymer melting-point temperature which is at least a minimum of about 60° C. Accordingly, the thermal-sticky polymer can suitably activate and soften to become operatively sticky during heating of the foam composite, allowing the layer containing active agent materials to more effectively bond to a surface of the thermoplastic foam layer. The thermal-sticky polymer can alternatively have a melt-temperature or softening-temperature of at least about 70° C., and can optionally have a melt-temperature or a softening-temperature of at least about 80° C. In another feature, the melt-temperature or a softening-temperature of the thermal-sticky polymer can be up to about 100° C., or more. In further aspects, the thermal-sticky polymer melt-temperature or a softening-temperature can be not more than about 220° C., and alternatively, can be not more than about 150° C. to provide improved performance. In general, it is desirable that the melt-temperature and/or a softening-temperature is lower than the melt-temperature of the thermoplastic foam layer. However, it is contemplated that a treatment-material melt-temperature and/or softening-temperature that is the same or higher than the melt-temperature of the thermoplastic foam layer may be desirable in certain applications.

If the melting temperature of the thermal-sticky polymer is outside the desired values, the treated active agent particles may not bond adequately, or may excessively stick together and undesirably agglomerate. Excessively stuck-together particles can undesirably reduce the efficiency and effectiveness of the process employed to produce the thermoplastic foam composite of the present invention. The excessively agglomerated particles may also reduce the efficacy of the thermoplastic foam composite itself.

The thermal-sticky polymer can also include a polymer that is hydrophilic and water soluble. In a particular feature, the coating polymer can be solution-coated onto the active agent materials by employing any operative application technique. Such solution coating techniques are conventional and well known in the art. The water solubility of the coating polymer can advantageously help to provide greater cohesion between the coating polymer and the active agent materials. The greater cohesion can then more effectively cooperate with the thermal processability of the coating polymer. As a result, the active agent materials can be more effectively held onto the desired surfaces of the thermoplastic foam layer. In another particular feature, the coating polymer can be coated onto the active agent by an emulsion in which the surface treatment is dissolved in an organic solvent mixed with water and a surfactant to form a stable suspension.

The active agent materials can be operatively surface treated with a thermal-sticky polymer that includes one or more constituents that exhibit desired thermoplastic properties. The selected constituents on the surface of the treated active agents can operatively soften or melt upon heating, such as upon contacting hot air or the hot surfaces of other objects during the bonding process. The heated thermal-sticky polymer can operatively form bonds with the foam layer. In addition, the thermal-sticky polymer can help to significantly enhance the retention of the active agents, and help reduce the amount of loose or unattached (i.e., insufficiently bonded) particles.

Any operative thermoplastic agent can be incorporated into the thermal-sticky polymer that is coated onto the surface of the active agents to enhance thermal stickiness. A particular aspect of the invention can include a thermal-sticky polymer which has been configured to provide an active agent, such as a superabsorbent material, with a desired Thermal Stickiness Index (TSI) value, which is further described in the TEST METHODS section of the present disclosure. A particular feature of the invention can include a superabsorbent material which exhibits a TSI value of at least about 40. The TSI value can alternatively be at least about 60, and can optionally be at least about 80 to provide improved benefits. In general, as TSI increases, the degree of bonding also increases. If the TSI parameter falls below the desired values, there can be insufficient bonding between the superabsorbent material layer and the foam layer surface. As a result, the foam composite can exhibit excessive amounts of loose or unattached (i.e., insufficiently bonded) active agent materials.

In a particular feature, the thermal-sticky polymer coating can include a hydrophilic thermoplastic polymer, which is thermally processable. Another feature of the invention can incorporate a thermal-sticky polymer coating that is thermally processable and water-soluble. In a further feature, the invention can include a solution coating process which places the thermal-sticky polymer onto the active agent particle and promotes strong bonds between the coating and the particles. Various distinctive factors can influence the effectiveness of thermal stickiness provided by the surface coating. Such factors can, for example, include the cohesion strength of the selected thermal-sticky coating material; the bond strength provided by the coating material; and the total number of bonds formed by the surface coating material. A thermally processable coating polymer with low cohesion can provide inadequate integrity and inadequate shake-out resistance even if perfect bonds are formed between the active agent particles and adjacent foam bonding sites. For example, wax is a thermally meltable polymer but provides insufficient cohesion. The low cohesion wax material is very easily torn apart and its corresponding bonds are easily breakable.

It is desirable to have a bond strength which minimizes or eliminates the separation of active agent materials from the foam layer surface. Bond strength refers to the total energy required to separate bonds at the interface between two materials. In general, materials of the same nature tend to have higher bond strength. For example, a hydrophilic polymer forms stronger bonds with another hydrophilic polymer than with a hydrophobic polymer.

An important interfacial structure between two polymers which can help enhance bonding integrity is a structure that has been referred to by the nomenclature of an Interpenetrating Polymer Network (IPN). IPN pertains to macromolecular chains of a polymer which penetrate through the interface into another polymer domain, or vice versa. Such a penetrating network can promote bond strength, and typically occurs only between compatible polymers. The process employed to coat the thermal-sticky polymer onto an active agent may affect the formation of the desired IPN structure. For example, when a thermally processable and water-soluble polymer (e.g., a hydroxypropyl cellulose, HPC, or a polyethylene oxide, PEO) is coated or otherwise applied onto an active agent (e.g., a crosslinked sodium polyacrylate), there are two primary coating techniques. One application technique is to spray fine droplets of the thermal-sticky polymer (e.g., molten HPC or PEO) onto the surface of the active agent materials. A second technique is to dissolve the thermal-sticky polymer into a solvent (such as water) to form a solution, and then mix the solution with dry active agent materials to allow the materials to absorb the solution. The first technique typically produces a coating with no IPN formation. The second technique can promote the formation of the IPN at the interface between the active agent material and the thermal-sticky polymer due to a swelling of the material, such as a superabsorbent particle, and a diffusion and penetration of water molecules into the materials during the operation of the coating technique.

The factors which relate to the total numbers of bonds formed in the absorbent composite can depend upon the morphology of the thermal-sticky polymer. When a hydrophobic polymer material is coated onto the surface of a hydrophilic active agent (for example, a superabsorbent material), the hydrophobic polymer can form droplets on the particle surface due to a lack of compatibility between the active agent and the coating polymer material. Such morphology can result in a low efficiency of utilization of the coating polymer (such efficiency is proportional to the coated surface area covered by the thermal-sticky polymer.) A hydrophilic coating material (e.g., a polymer that is hydrophilic, thermally processable and water soluble) can have greater compatibility with a superabsorbent polymer, and can be more capable of forming a more extensive thin layer of the coating material. The coating layer can cover the whole (or approximately the whole) outer-surface of such a particle when the particle is coated by a solution coating process. The resulting morphology can produce a significantly larger amount of particle surface area that is coated by the thermal-sticky polymer coating material while employing a reduced amount of the coating material. As a result, the coating material can be utilized with significantly higher efficiency. The higher utilization efficiency of the coating material can increase the number of bonds formed between active agent materials and surfaces of the foam layer.

In some aspects, the thermal-sticky polymer is thermally processable and can optionally be water soluble. Such coating materials have a melting or softening temperature (i.e., Tₘ) and are capable of dissolving in water. Suitable thermally processable and water soluble coating polymers include, but are not limited to, modified polyvinyl alcohol, polyethylene oxide, polypropylene oxide, ethylene oxide-propylene oxide copolymer, polyethylene glycol, polypropylene glycol, ethylene glycol-propylene glycol copolymer, polyacrylic acid copolymers, quaternary ammonium acrylate, methacrylate, or acrylamide copolymers, modified polysaccharides, such as hydroxypropyl cellulose, methyl cellulose, methyl ethyl cellulose, polyethylene imine, as well as mixtures or other combinations thereof.

A particular molecular weight of the selected thermal-sticky polymer can also be desirable. In general, a higher molecular weight polymer can provide a desired, higher intrinsic cohesion. However, when the molecular weight of a coating polymer is too high, an aqueous solution of the coating polymer can have an excessive level of viscosity, which may potentially create difficulties in conducting desired surface treating operations. In some aspects of the invention, the molecular weight of the thermal-sticky polymer can be at least a minimum of about 5,000. The molecular weight can alternatively be at least about 10,000, and can optionally be about 50,000. In other aspects the molecular weight of the surface treatment material can be up to a maximum of about 10,000,000. The molecular weight can alternatively be not more than about 1,000,000, and can optionally be not more than about 500,000 to provide improved benefits.

As previously mentioned, the thermal-sticky polymer can desirably be coated onto the surface of the active agent materials by employing a solution (e.g. an aqueous solution) of the surface treatment material to promote the formation of a desired IPN. When the thermal-sticky polymer is dissolved into an operative solution, the solution can have a selected concentration of the thermal-sticky polymer. In a particular feature, the concentration of the thermal-sticky polymer in solution can be at least a minimum of about 0.01% by weight. The concentration of the thermal-sticky polymer can alternatively be at least about 0.1% by weight, and can optionally be at least about 0.5% by weight to provide improved benefits. In other aspects, the concentration of the thermal-sticky polymer can be up to a maximum of about 20% by weight, or more. The concentration of the thermal-sticky polymer can alternatively be up to about 10% by weight, and can optionally be up to about 5% by weight to provide improved effectiveness.

If the molecular weight and/or concentration of the thermal-sticky polymer is outside the desired values, the coating polymer may not adequately provide a desired, deeper penetration into the active agent materials. As a result, the active agent materials may exhibit insufficient levels of thermal stickiness and bonding strength.

A selected amount of the thermal-sticky polymer can be coated onto the surfaces of active agent materials to provide a desired, overall thermal stickiness of the coated active agent materials. In a particular aspect, the coating amount can be at least a minimum of about 0.1% by weight, as determined with respect to the total dry weight of the coated active agent material. The coating amount can alternatively be at least about 0.3% by weight, and can optionally be at least about 0.5% by weight to provide improved benefits. In other aspects, the coating amount of the thermal-sticky polymer can be up to a maximum of about 10% by weight, or more. The coating amount can alternatively be up to about 7% by weight, and can optionally be up to about 5% by weight to provide improved effectiveness.

When the desired active agents have been, coated as described herein, a layer of the coated active agent materials can be applied to at least one surface of the thermoplastic foam layer. The layer can be applied evenly or unevenly, and can be applied randomly or in a desired pattern. The thickness of the individual layers and of the composite itself can be varied depending on the intended use of the composite. For example, if the composite is being used as a component of an absorbent article, it may have a thickness of from about 1 mm to about 1 cm.

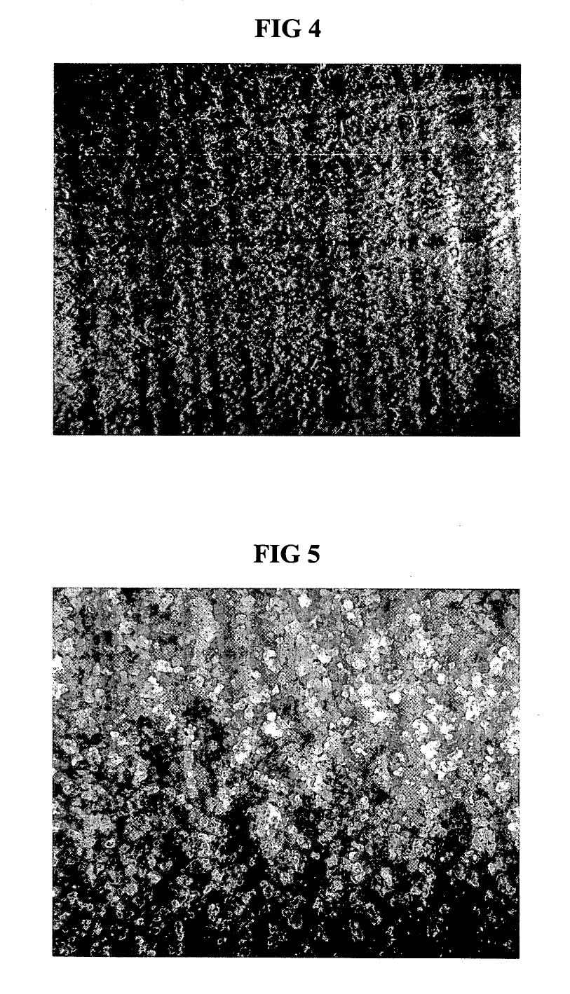

When the active agent layer has been applied, it can be compressed onto the foam surface by using pressure means known in the art. Compression can help ensure good contact between the surface of the thermoplastic foam layer and the active agent layer and/or between the active agent materials within the active agent layer. After application of the active agent layer, the foam composite can be heated to activate the thermal-sticky polymer coating. For example, in one particular feature, superabsorbent particles coated with PEO were pressed onto a surface of a thermoplastic foam layer by compressing the composite under a pressure of about 20 psi for about 10 seconds. The composite was then heated in a Model No. DK-63 laboratory oven (available from Scientific Products, a division of Baxter Diagnostics, a business having offices located in McGaw Park, Ill., U.S.A.) at 80° C. for about 30 minutes. FIG. 4 is a photomicrograph at 8× magnification illustrating a surface of a thermoplastic foam layer in accordance with the present invention. FIG. 5 is a photomicrograph at 8× magnification illustrating a foam composite comprising superabsorbent particles that have been coated with PEO, then pressed into the foam layer of FIG. 4 at 20 psi for 10 seconds, and then heated to 80° C. for 30 minutes to form a thermoplastic foam composite of the present invention.

In some aspects, it may be desirable to utilize an adhesive, such as a hot melt adhesive, to further improve the bonding of the coated active agent layer to the thermoplastic foam layer surface. Such an adhesive can be utilized in an amount of about 10% or less by weight of the foam layer. Suitable adhesives are well known in the art. In one particular feature, NS 34-5610 hot melt adhesive (available from National Starch and Chemical Company, a business having offices located in Chicago, Ill., U.S.A.) is utilized in an amount of about 10% by weight of the foam layer to provide improved benefits. Other suitable adhesives include, but are not limited to, pressure sensitive hot melt construction/elastic attachment adhesives such as H2525A, H2840 and H2808 elastic attachment adhesives from Bostick Findley (a business having offices located in Milwaukee, Wis., U.S.A.).

As mentioned above, the thermoplastic foam of the present invention can be utilized as an article such as a packaging, wiper, absorbent mat, or insulation product, or can be incorporated as a component into a variety of other articles, including personal care articles, health/medical articles, and household/industrial articles. The foam composite can also be used in a wide array of applications including clothing components, filters, thermal and acoustic insulation, shock and cushion absorbing products, athletic and recreation products, construction and packaging uses, and cleaning applications such as sponges and wipes for oleophilic and/or hydrophilic fluids.

Additionally, the foam composite of the present invention can be further combined with other various layers to form laminates, which can then be utilized as articles or as components of articles. The foam composite of the present invention can also be further incorporated with a reinforcing material such as scrim, spunbond, meltblown web, netting, or woven material. For example, in a foam composite laminate, an open-mesh reinforcing member, such as spunbond, may be sandwiched between a fiber layer and the foam composite to form a reinforced absorbent product. Inclusion of such a material could serve to improve wet strength and integrity, to shape the structure, and to curtail possible hydrated foam expansion. In another example, a stretchable nonwoven layer comprising superabsorbent material may be bonded to the foam composite of the present invention using techniques known in the art (such as by as ultrasonic bonding, pressure bonding, adhesive bonding, heat bonding, sewing thread or strand, hook-and-loop or any combination thereof) to form a laminate. In still another example, fibers can be incorporated into the laminate, such as by hydraulic jet treating or mechanical needling, so as to form fiber pathways for directing fluid through the foam layer and into the layer comprising active agents. Alternatively, a second foam layer may be hydraulically needled with a fibrous layer, and the second foam layer may then be laminated to the foam composite of the present invention such that pockets of active agent materials are strategically sandwiched between the foam layers.

In some aspects, such as an absorbent article, the foam composite of the present invention may comprise active agents in the form of odor control particles to function as a topsheet and/or backsheet for the absorbent article. In other aspects, the foam composite can comprise active agents in the form of fluid modification particles, to function as a surge layer for the absorbent article. In still other aspects, the foam composite can comprise active agents in the form of superabsorbent materials, to function as an absorbent core component of the absorbent article. In yet other aspects, the foam composite can utilize the foam layer for temporary storage and distribution of fluid and the active agent layer for permanent storage of fluid.

Disposable absorbent articles often include a fluid pervious topsheet, a backsheet joined to the topsheet, and an absorbent core positioned and held between the topsheet and the backsheet. An absorbent article may also include other components, such as fluid wicking layers, fluid intake layers, fluid distribution layers, transfer layers, storage layers, barrier layers, wrapping layers, and the like, as well as combinations thereof.

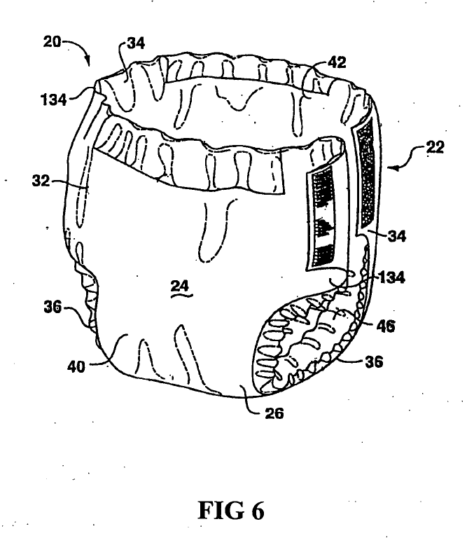

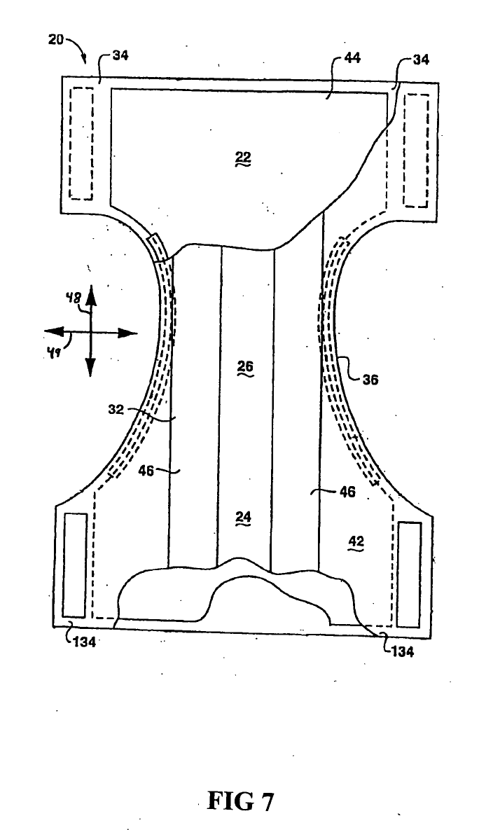

Referring to FIGS. 6 and 7 for exemplary purposes, a training pant which may incorporate the present invention is shown. It is understood that the present invention is suitable for use with various other articles, including but not limited to other personal care articles, health/medical articles, household/industrial articles, and the like without departing from the scope of the present invention.

Various materials and methods for constructing training pants are disclosed in PCT Patent Application WO 00/37009 published Jun. 29, 2000 by A. Fletcher et al.; U.S. Pat. No. 4,940,464 to Van Gompel et al.; U.S. Pat. No. 5,766,389 to Brandon et al.; and U.S. Pat. No. 6,645,190 to Olson et al., all of which are incorporated herein by reference in a manner that is consistent herewith.

FIG. 6 illustrates a training pant in a partially fastened condition, and FIG. 7 illustrates a training pant in an opened and unfolded state. The training pant defines a longitudinal direction 48 that extends from the front of the training pant when worn to the back of the training pant. Perpendicular to the longitudinal direction 48 is a lateral direction 49.

The training pant defines a front region 22, a back region 24, and a crotch region 26 extending longitudinally between and interconnecting the front and back regions. The pant also defines an inner surface adapted in use (e.g., positioned relative to the other components of the pant) to be disposed toward the wearer, and an outer surface opposite the inner surface. The training pant has a pair of laterally opposite side edges and a pair of longitudinally opposite waist edges.

The illustrated pant 20 may include a chassis 32, a pair of laterally opposite front side panels 34 extending laterally outward at the front region 22 and a pair of laterally opposite back side panels 134 extending laterally outward at the back region 24.

The chassis 32 includes a backsheet 40 and a topsheet 42 that may be joined to the backsheet 40 in a superimposed relation therewith by adhesives, ultrasonic bonds, thermal bonds or other conventional techniques. The chassis 32 may further include an absorbent core 44 such as shown in FIG. 7 in the form of the foam composite of the present invention disposed between the backsheet 40 and the topsheet 42 for absorbing fluid body exudates exuded by the wearer, and may further include a pair of containment flaps 46 secured to the topsheet 42 or the absorbent core 44 for inhibiting the lateral flow of body exudates.

The backsheet 40, the topsheet 42 and the absorbent core 44 may be made from many different materials known to those skilled in the art. For instance, they may be extensible and/or elastomeric. Further, the stretch properties of each layer, including the foam composite 44, may vary in order to control the overall stretch properties of the product.

The backsheet 40, for instance, may be breathable and/or may be fluid impermeable. The backsheet 40 may be constructed of a single layer, multiple layers, laminates, spunbond fabrics, films, meltblown fabrics, elastic netting, microporous webs, bonded-carded-webs or foams provided by elastomeric or polymeric materials. The backsheet 40, for instance, can be a single layer of a fluid impermeable material, or alternatively can be a multi-layered laminate structure in which at least one of the layers is fluid impermeable. In one aspect, the foam composite of the present invention can function as the backsheet 40.

The backsheet 40 can be biaxially extensible and optionally biaxially elastic. Elastic non-woven laminate webs that can be used as the backsheet 40 include a non-woven material joined to one or more gatherable non-woven webs, films, or foams. Stretch Bonded Laminates (SBL) and Neck Bonded Laminates (NBL) are examples of elastomeric composites.

Examples of suitable nonwoven materials are spunbond-meltblown fabrics, spunbond-meltblown-spunbond fabrics, spunbond fabrics, meltblown fabrics or laminates of such fabrics with films, foams or other nonwoven webs. Elastomeric materials may include cast or blown films, foams, meltblown fabrics, or spunbond fabrics composed of polyethylene, polypropylene or polyolefin elastomers, as well as combinations thereof. The elastomeric materials may include PEBAX elastomer (available from AtoFina Chemicals, Inc., a business having offices located in Philadelphia, Pa., U.S.A.), HYTREL elastomeric polyester (available from Invista, a business having offices located in Wichita, Kans., U.S.A.), KRATON elastomer (available from Kraton Polymers, a business having offices located in Houston, Tex., U.S.A.), or strands of LYCRA elastomer (available from Invista) or the like, as well as combinations thereof. The backsheet 40 may include materials that exhibit elastomeric properties which have been imparted through a mechanical process, printing process, heating process or chemical treatment. For example, such materials may be apertured, creped, neck-stretched, heat activated, embossed and/or micro-strained; and may be in the form of films, webs and laminates.

One example of a suitable material for a biaxially stretchable backsheet 40 is a breathable elastic film/nonwoven laminate, such as described in U.S. Pat. No. 5,883,028, to Morman et al., incorporated herein by reference in a manner that is consistent herewith. Examples of materials having two-way stretchability and retractability are disclosed in U.S. Pat. No. 5,116,662 to Morman and U.S. Pat. No. 5,114,781 to Morman, each of which is incorporated herein by reference in a manner that is consistent herewith. These two patents describe composite elastic materials capable of stretching in at least two directions. The materials have at least one elastic sheet and at least one necked material, or reversibly necked material, joined to the elastic sheet at least at three locations arranged in a nonlinear configuration, so that the necked, or reversibly necked, web is gathered between at least two of those locations.

The topsheet 42 is suitably compliant, soft-feeling and non-irritating to the wearer's skin. The topsheet 42 is also sufficiently liquid permeable to permit liquid body exudates to readily penetrate through its thickness to the foam composite 44. A suitable topsheet 42 may be manufactured from a wide selection of web materials, such as porous foams, reticulated foams, apertured plastic films, woven and non-woven webs, or a combination of any such materials. For example, the topsheet 42 may include a meltblown web, a spunbonded web, or a bonded-carded-web composed of natural fibers, synthetic fibers or combinations thereof. The topsheet 42 may be composed of a substantially hydrophobic material, and the hydrophobic material may optionally be treated with a surfactant or otherwise processed to impart a desired level of wettability and hydrophilicity. In one aspect, the foam composite of the present invention may be used as the topsheet 42.

The topsheet 42 may also be extensible and/or elastomerically extensible. Suitable elastomeric materials for construction of the topsheet 42 can include elastic strands, LYCRA elastics, cast or blown elastic films, nonwoven elastic webs, meltblown or spunbond elastomeric fibrous webs, as well as combinations thereof. Examples of suitable elastomeric materials include KRATON elastomers, HYTREL elastomers, ESTANE elastomeric polyurethanes (available from Noveon, a business having offices located in Cleveland, Ohio, U.S.A.), or PEBAX elastomers. The topsheet 42 can also be made from extensible materials such as those described in U.S. Pat. No. 6,552,245 to Roessler et al., which is incorporated herein by reference in a manner that is consistent herewith. The topsheet 42 can also be made from biaxially stretchable materials as described in U.S. Pat. No. 6,641,134 filed to Vukos et al., which is incorporated herein by reference in a manner that is consistent herewith.

The article 20 can optionally further include a surge management layer which may be located adjacent to the absorbent core 44 and attached to various components in the article 20 such as the absorbent core 44 or the topsheet 42 by methods known in the art, such as by using an adhesive. In general, a surge management layer helps to quickly acquire and diffuse surges or gushes of liquid that may be rapidly introduced into the absorbent structure of the article. The surge management layer can temporarily store the liquid prior to releasing it into the storage or retention portions of the absorbent core 44. Examples of suitable surge management layers are described in U.S. Pat. No. 5,486,166 to Bishop et al.; U.S. Pat. No. 5,490,846 to Ellis et al.; and U.S. Pat. No. 5,820,973 to Dodge et al., each of which is incorporated herein by reference in a manner that is consistent herewith. In one aspect, the foam composite of the present invention may be used as the surge layer.

The article 20 can further comprise an absorbent body structure, and the absorbent body can include the foam composite of the present invention as the absorbent core 44 component. In some aspects, the foam composite can also have a significant amount of stretchability. Accordingly, the article can comprise a stretchable thermoplastic foam composite of the present invention to function as the absorbent core 44. Such a foam composite can include an operative amount of elastomeric polymer, and superabsorbent particles as the active agent material.

The absorbent core 44 may have any of a number of shapes. For example, the absorbent core 44 may be rectangular shaped, triangular shaped, oval shaped, race-track shaped, I-shaped, generally hourglass shaped, T-shaped, and the like. It is often suitable for the absorbent core 44 to be narrower in the crotch portion 26 than the rear 24 or front 22 portion(s). The absorbent core 44 can be attached to an absorbent article by bonding means known in the art, such as ultrasonic, pressure, adhesive, heat, sewing thread or strand, autogenous (i.e., self-adhering), hook-and-loop or any combination thereof. For example, the absorbent core 44 may be bonded to the topsheet, the backsheet, or both, of an absorbent article.

The present invention may be better understood with reference to the following examples.

### EXAMPLES

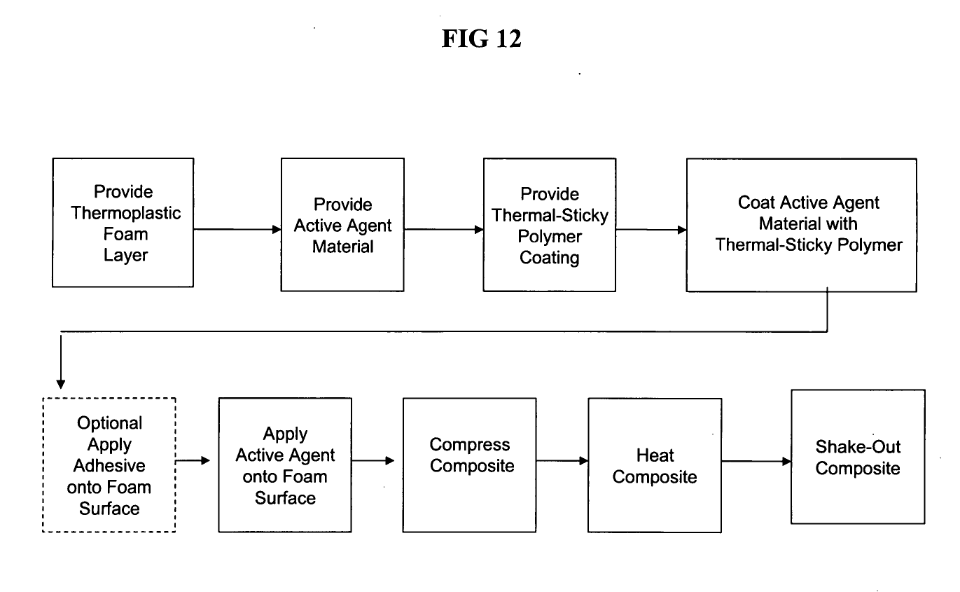

The foam composites produced in the following examples of the invention were made by producing a thermoplastic foam layer, forming a thermal-sticky polymer coating solution, applying the coating solution to an active agent material, and applying the coated active agent material to form a layer that is then bonded to the thermoplastic foam layer. An exemplary process for making the foam composite of the present invention can be seen in FIG. 12. Unless otherwise stated, samples were made under conditions 23±1 degrees Celsius and 50±2 percent relative humidity.

Foam Layer

A thermoplastic foam layer was produced using a foam formula comprising 48.6% by weight STYRON 685 D base polystyrene resin polymer (available from Dow Chemical Company, a business having offices located in Midland, Mich., U.S.A.), 40% by weight of KRATON G1657 thermoplastic elastomer (available from Kraton Polymers, a business having offices located in Belpre, Ohio, U.S.A.), 5.4% by weight HOSTASTAT 3301 surfactant (available from Clariant Corporation, a business having offices located in Winchester, Va., U.S.A.) and 6% by weight Hydrocerol CF-40-T (also available from Clariant Corporation). In addition, a physical blowing agent was employed comprising, 6% by weight iso-pentane, where the weight percent was determined with respect to the polymer and additive blends above.

The foam layer was formed by placing the foam formula mixture into a tandem extrusion system and annular die similar to that described in U.S. Pat. No. 6,273,697 to Harfmann and U.S. Pat. No. 6,638,985 to Gehlsen (which are incorporated herein by reference in a manner that is consistent herewith), or equivalents. The primary extruder temperature and screw speed were adjusted to ensure complete polymer and additive melting and mixing and the secondary extruder temperature was adjusted to achieve the desired melt temperature profile to produce the thermoplastic foam layer. The die pressure was achieved by controlling the die gap and extruder screw speeds. The extruded foam was pulled over a cooling mandrel, slit, and wound in a roll. The process parameters can be seen in Table 1 below.

TABLE 1
Foam Layer Process Parameters

| | | | | | Open |
|---|---|---|---|---|---|
| Die | Die | Melt | Basis | | Cell |
| Temperature | Pressure | Temperature | Weight | Density | Content |
| (° F.) | (psig) | (° F.) | (gsm) | (g/cc) | (%) |
| 295 | 796 | 289 | 157 | 0.072 | 88 |

The resulting foam sheet was then post-formation treated by cutting the sheet into hand samples having dimensions of approximately 30 cm×30 cm, and then placing each sample onto the line wire of a hydraulic jet machine (similar to that illustrated in FIG. 3) to puncture the skin of the foam layer and to improve, among other things, absorbency, cellular orientation, aesthetics, softness, and similar properties. The samples were hydraulically jet treated using a Honeycomb Systems manifold (available from Honeycomb Systems Inc., a business having offices located in Biddeford, Me., U.S.A.) having a jet strip with 0.005 inch diameter orifices, and with 40 orifices per linear inch arranged in a single row (available from Nippon Nozzle, a business having offices located in Kobe, Japan). The line wire speed was set 25 feet per minute, the dewatering vacuum level under the manifold was adjusted to 20 inches of Hg (to ensure adequate dewatering), and the pressure of the water jets was adjusted to 1000 psig to adequately open the skin of the foam to make it liquid permeable. Each hand sample was passed under the manifold four times, twice per side. Each foam layer was then dewatered using the wire vacuum and was air dried overnight.

Thermal-Sticky Polymer Coatinq

A 2.5% by weight PEO thermal-sticky polymer coating solution was prepared by mixing polyethylene oxide having a molecular weight (M_{w}) of about 600,000 (available from Aldrich Chemical Company, Inc.) with water. More specifically, the coating solution was prepared by dissolving 12.5 grams of the polyethylene oxide (PEO) in 1,250 grams of distilled water to make a 1% by weight solution. The dry powder of the polyethylene oxide was slowly added into the 1 gallon mixing bowl of a HOBART Mixer, model N-50 (available from Hobart Canada, a business having offices located in North York, Ontario, Canada) containing the 1,250 grams of distilled water while the mixer was set at the stirring setting “1.” The solution was stirred for 60 minutes until a homogenous solution was obtained.

Additionally, a 5.0% by weight PEO thermal-sticky polymer coating solution was prepared by dissolving 25 grams of the polyethylene oxide (PEO) having a M_{w} of about 600,000 (available from Aldrich Chemical Company, Inc.) in 1,250 grams of distilled water to make a 2% by weight solution. The dry powder of the polyethylene oxide was slowly added into the mixing bowl of the model N-50 HOBART Mixer containing the 1,250 grams of distilled water while the mixer was stirred at the stirring setting “1.” The solution was stirred until a homogenous solution was obtained.

Coating the Active Agent Material

500 grams of active agent material in the form of dry FAVOR SXM 9394 superabsorbent material (SAM) having a particle size range from 0 to 850 micrometers (μm) were added to each of the coating solutions described above while stirring at the above-described stirring setting for about 2 minutes. The coated, swollen superabsorbent particles were then removed from the coating solution mixing bowl and placed on a pan. Each pan was placed in a Model No. DK-63 laboratory oven set at 80° C. until the particles were completely dried. The dried, coated superabsorbent particles were de-agglomerated with a GRANU-GRINDER, available from C.W. Brabender, a business having offices located in Hackensack, N.J., U.S.A. The coated superabsorbent particles were then sieved to remove particles larger than 850 microns.

Foam Composite

The coated superabsorbent particles were then sieved once again with various sieves to obtain desired particle sizes according to Tables 2 and 3 below. A desired amount of coated particles was then placed evenly onto each thermoplastic foam layer. The amount of superabsorbent materials added onto the thermoplastic foam layer prior to subjecting the composite to performing a Shake-Out Procedure (described below) can be seen in Table 3 below. In some samples, a designated amount of NS 34-5610 adhesive (as seen in Table 2 below) was uniformly meltblown at a temperature of 340° F. (171.1° C.) onto the foam layer surface using a PAM 600 SPRAYMATIC hotmelt spreading gun (available from Fastening Technologies, Inc., a business having offices located in Charlotte, N.C., U.S.A.) prior to placement of the thermal-sticky polymer coated superabsorbent particles. In other samples, a designated amount (as seen in Table 2 below) of 3.3% PEO aqueous solution was uniformly applied to a foam layer surface using a 3.81 cm paint brush prior to placement of the coated superabsorbent particles. In addition, several comparative examples were made using uncoated superabsorbent materials, which can also be seen in Table 2 below.

Each thermoplastic foam layer comprising thermal-sticky polymer coated (or coated) superabsorbent material on a surface was then compressed using an unheated CARVER PRESS (available from Carver, Inc., a business having offices located in Wabash, Ind., U.S.A.) with suitable shims placed at the each corner of the samples. The shims had a thickness that was equal to the thickness of the thermoplastic foam layer, and the foam composite was then subjected to a pressure of 20 psi for about 10 seconds. The composite was then placed in the DK-63 laboratory oven set at 80° C. for about 30 minutes to form a sandpaper-like foam/superabsorbent composite.

When cooled and exposed to air at about 23±1 degrees Celsius and 50±2 percent relative humidity for more than 12 hours, the composite was subjected to the Shake-Out Procedure (described below), and the weight of remaining superabsorbent material was recorded (as seen in Table 2). Each sample was then tested for centrifuge retention capacity (using the Centrifuge Retention Capacity Test described below) and for saturated capacity (using the Saturated Capacity Test described below), the results of which can be seen in Table 2. Some samples were additionally tested for flexibility and/or softness using the Bending Modulus Test (described below.)

Shake-Out Procedure

In order to remove insufficiently bonded superabsorbent material (SAM) from the thermoplastic foam composite, the composite was subjected to a Shake-Out Procedure. The susceptibility of a superabsorbent material to migrate and detach from the foam composite can be measured by employing a procedure which involves agitating the composite samples in a controlled fashion. A sample of the thermoplastic foam composite was prepared in the shape of a rectangular plate which can have varied sizes.

The Shake-Out Procedure can be conducted by employing a Model # RX-24 PORTABLE SIEVE SHAKER (herein after referred to as “RX-24”) available from W.S. Tyler Inc., a business having offices located in Mentor, Ohio, U.S.A. The shaker apparatus was modified in the manner described in PCT publication WO 02/076520, which corresponds to U.S. Patent Application Publication 2002/0183703 Al, which is incorporated herein by reference in a manner that is consistent herewith. More specifically, the RX-24 was modified to shake foam composite samples. The modifications to the shaker apparatus involve making changes to the guide frame in the manner described in PCT publication WO 02/076520. In addition to the changes to the guide frame described in this PCT publication, a modified sample holder was employed wherein the sample holder utilized a frame made of polyacrylate plate and two pieces of mesh screen. The frame had a length of 17 inches (43.18 cm), a width of 11.5 inches (29.21 cm) and a thickness of 0.20 inch (0.51 cm). The frame had a rectangular opening with a length of 15.25 inches (38.74 cm) and a width of 6.25 inches (15.88 cm), and the opening was substantially centered in the frame. One piece of mesh screen with a dimension slightly larger than the opening was operatively joined on each side of the frame (e.g. with duct tape) to hold the test sample. The mesh screen had 0.4 cm x 0.4 cm square openings, and the total weight of the sample holder was about 500 grams. A substantially equivalent shaker system may optionally be employed.

To perform the Shake-Out Procedure, the composite sample was laid at the center of the sample holder with the active agent coated surface facing up, and the sample holder was laid horizontally flat (i.e. parallel to the floor) upon the wire screen employed to support the sample on the modified RX-24. The RX-24 was then engaged to shake each sample at a frequency of approximately 520 cycles per minute for a period of five minutes.

After the completion of the shaking portion of the procedure, the sample was removed from the sample holder and turned over such that the active agent coated surface faced down to remove the loose active agent particles. Each sample was then weighed to determine the final weight of the shaken thermoplastic composite sample and the final SAM add-on level was calculated, in accordance with the following formula:
SAM Add-On Level (%)=100%×((Mₜ−M_{f})÷Mₜ)
where: M_{f}=foam weight prior to addition of active agent (e.g. grams);
   Mₜ=total sample weight remaining after shake out (e.g. grams).

The mass of active agent material that is lost from each sample will generally fall through the openings in the support screen. Any mass that remains on the screen is counted as mass loss.

TABLE 2
Thermoplastic Foam Composite Samples

| | | | | | | | | | Sat. | |
|---|---|---|---|---|---|---|---|---|---|---|
| | | | | | | SAM | | CRC | Cap. | |
| | | | | Adhesive | | Weight | SAM % | of the | of the | Bending |
| | | Foam | | Dry | | after | (add- | treated | treated | modulus |
| | Foam | Weight | Adhesive | Weight | SAM | Shake- | on | foam | foam | @0.5 mm |
| Sample # | Type | (g) | Type | (g) | Type | Out (g) | level) | (g/g) | (g/g) | (g/mm2) |
| 1 - | Thermoplastic | 1.48 | None | 0 | FAVOR | 0 | 0 | 1.7 | 7.44 | 135 |
| comparative | | | | | SXM 9394 | | | | | |
| | | | | | (0-850 μm) | | | | | |
| 2 | Thermoplastic | 3.28 | None | 0 | 2.5% PEO | 3.18 | 49.2 | 10.5 | | |
| | | | | | treated | | | | | |
| | | | | | FAVOR | | | | | |
| | | | | | SXM 9394 | | | | | |
| | | | | | (0-600 μm) | | | | | |
| 3 | Thermoplastic | 1.47 | None | 0 | 5% PEO | 3.53 | 70.6 | 16.9 | 19.92 | |
| | | | | | treated | | | | | |
| | | | | | FAVOR | | | | | |
| | | | | | SXM 9394 | | | | | |
| | | | | | (0-850 μm) | | | | | |
| 4 - | Thermoplastic | 3.50 | NS 34- | 0.53 | FAVOR | 2.51 | 38.4 | 9.42 | | |
| comparative | | | 5610 | | SXM 9394 | | | | | |
| | | | | | (300-600 μm) | | | | | |
| 5 | Thermoplastic | 4.75 | NS 34- | 0.47 | 5% PEO | 8.97 | 63.2 | 16.04 | 20.49 | |
| | | | 5610 | | treated | | | | | |
| | | | | | FAVOR | | | | | |
| | | | | | SXM 9394 | | | | | |
| | | | | | (300-600 μm) | | | | | |
| 6 - | Thermoplastic | 3.50 | NS 34- | 0.53 | FAVOR | 1.94 | 32.5 | 6.99 | | |
| comparative | | | 5610 | | SXM 9394 | | | | | |
| | | | | | (0-300 μm) | | | | | |
| 7 | Thermoplastic | 4.75 | NS 34- | 0.47 | 5% PEO | 7.54 | 59.0 | 10.37 | 15.8 | 101.5 |
| | | | 5610 | | treated | | | | | |
| | | | | | FAVOR | | | | | |
| | | | | | SXM 9394 | | | | | |
| | | | | | (0-300 μm) | | | | | |
| 8 - | Thermoplastic | 3.15 | 3.3 wt % | 0.12 | FAVOR | 1.75 | 34.9 | 9.53 | | |
| comparative | | | PEO | | SXM 9394 | | | | | |
| | | | aqueous | | (0-600 μm) | | | | | |
| | | | solution | | | | | | | |
| 9 | Thermoplastic | 3.23 | 3.3 wt % | 0.127 | 2.5% PEO | 5.85 | 63.4 | 18.1 | | |
| | | | PEO | | treated | | | | | |
| | | | aqueous | | FAVOR | | | | | |
| | | | solution | | SXM 9394 | | | | | |
| | | | | | (0-600 μm) | | | | | |
| 10 | Thermoplastic | 1.97 | 3.3 wt % | 0.165 | 2.5% PEO | 4.29 | 66.7 | 17.6 | | 73.6 |
| | | | PEO | | treated | | | | | |
| | | | aqueous | | FAVOR | | | | | |
| | | | solution | | SXM 9394 | | | | | |
| | | | | | (0-600 μm) | | | | | |

It can be seen that the samples comprising thermal-sticky coated superabsorbent materials (SAM) resulted in superior bonding, as seen by the SAM weight after shake-out. As a result, the samples of the present invention demonstrate superior absorbent properties (i.e., centrifuge retention capacity and saturated capacity) when compared to the samples containing untreated particles.

TABLE 3
Effect of TSI on Bonding of the Active Agent Layer to the
Thermoplastic Foam Layer

| | | | | | Heat Temp. & | | | |
|---|---|---|---|---|---|---|---|---|
| | Foam | Adhesive | | | TSI | | Original | Final |
| | Weight | | Wt | | Temp. | | SAM | SAM |
| Sample # | (g) | Type | (g) | SAM Type | ° C.* | TSI** | Wt (g) | Wt (g) |
| 1 - | 1.48 | NA | 0 | SXM 9394 | 80 | 0 | 4.03 | 0 |
| comparative | | | | (0-850 μm) | | | | |
| 2 | 3.28 | NA | 0 | 2.5% PEO | 80 | 100 | 5.39 | 3.18 |
| | | | | treated SXM | | | | |
| | | | | 9394 (0-600 μm) | | | | |
| 3 | 1.47 | NA | 0 | 5% PEO | 80 | 100 | 4.04 | 3.53 |
| | | | | treated SXM | | | | |
| | | | | 9394 | | | | |
| | | | | (0-850 μm) | | | | |
| 5 | 4.75 | NS 34- | 0.47 | 5% PEO | 80 | 100 | 16.53 | 8.97 |
| | | 5610 | | treated SXM | | | | |
| | | | | 9394 | | | | |
| | | | | (300-600 μm) | | | | |
| 7 | 4.75 | NS 34- | 0.47 | 5% PEO | 80 | 100 | 10.47 | 7.54 |
| | | 5610 | | treated SXM | | | | |
| | | | | 9394 | | | | |
| | | | | (0-300 μm) | | | | |
| 9 | 3.23 | 3.3 wt % | 0.127 | 2.5% PEO | 80 | 100 | 8.34 | 5.85 |
| | | PEO | | treated SXM | | | | |
| | | aqueous | | 9394 | | | | |
| | | solution | | (0-300 μm) | | | | |
| 10 | 1.97 | 3.3 wt % | 0.165 | 2.5% PEO | 80 | 100 | 8.95 | 4.29 |
| | | PEO | | treated SXM | | | | |
| | | aqueous | | 9394 | | | | |
| | | solution | | (0-300 μm) | | | | |
| 11 - | 3.56 | NA | 0 | 2.5% PEO | 25 | 0 | 3.50 | 0 |
| comparative | | | | treated SXM | | | | |
| | | | | 9394 (0-850 μm) | | | | |
| 12 - | 1.53 | NA | 0 | 5% PEO | 25 | 0 | 4.56 | 0 |
| comparative | | | | treated SXM | | | | |
| | | | | 9394 | | | | |
| | | | | (0-850 μm) | | | | |
| 13 - | 3.53 | NA | 0 | 2.5% PEO | 50 | 1.8 | 4.23 | 0 |
| comparative | | | | treated SXM | | | | |
| | | | | 9394 (0-850 μm) | | | | |

Note:
*Temperature here represents both temperatures for TSI testing and SAM/foam heating treatment;
**TSI of each respective superabsorbent was tested according to the TSI Testing Procedure at the specified temperature

It can be seen that at temperatures above 60° C., a Thermal Sticky Index of 100 was obtained which resulted in desirable bonding of the active agent layer to the thermoplastic foam layer. However, at temperatures below 60° C., poor bonding resulted.

Test Procedures

Saturated Capacity Test

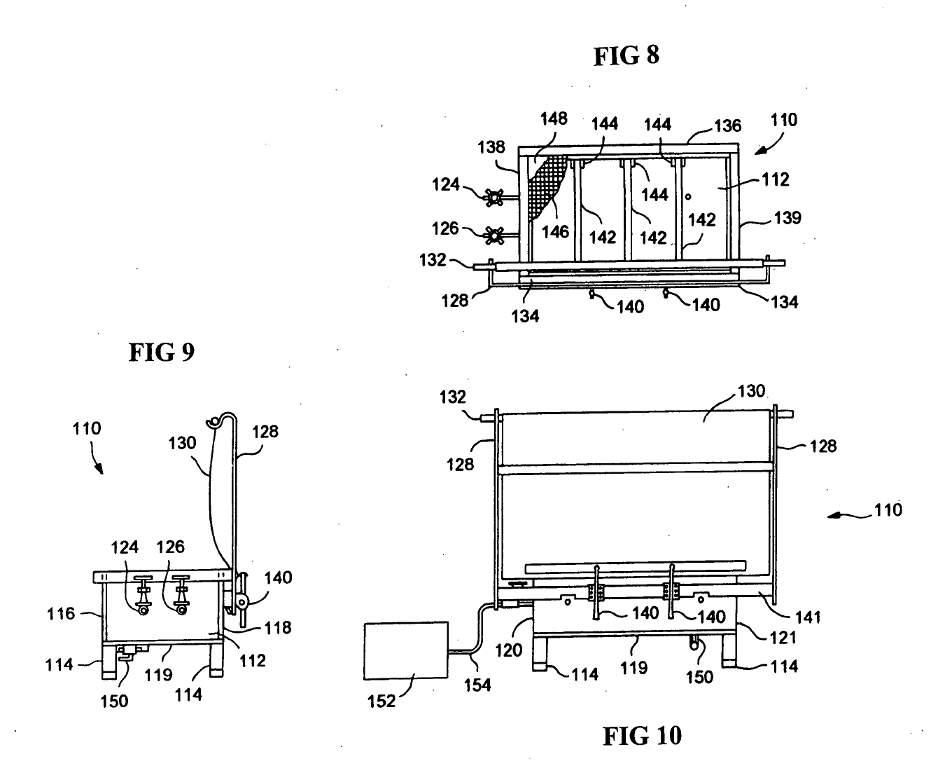

Saturated Capacity is determined using a Saturated Capacity (SAT CAP) tester with a Magnahelic vacuum gage and a latex dam, comparable to the following description. Referring to FIGS. 8-10, a Saturated Capacity tester vacuum apparatus 110 comprises a vacuum chamber 112 supported on four leg members 114. The vacuum chamber 112 includes a front wall member 116, a rear wall member 118, and two side walls 120 and 121. The wall members are sufficiently thick to withstand the anticipated vacuum pressures, and are constructed and arranged to provide a chamber having outside dimensions measuring 23.5 inches in length, 14 inches in width and 8 inches in depth.

A vacuum pump (not shown) operably connects with the vacuum chamber 112 through an appropriate vacuum line conduit and a vacuum valve 124. In addition, a suitable air bleed line connects into the vacuum chamber 112 through an air bleed valve 126. A hanger assembly 128 is suitably mounted on the rear wall 118 and is configured with S-curved ends to provide a convenient resting place for supporting a latex dam sheet 130 in a convenient position away from the top of the vacuum apparatus 110. A suitable hanger assembly can be constructed from 0.25 inch diameter stainless steel rod. The latex dam sheet 130 is looped around a dowel member 132 to facilitate grasping and to allow a convenient movement and positioning of the latex dam sheet 130. In the illustrated position, the dowel member 132 is shown supported in a hanger assembly 128 to position the latex dam sheet 130 in an open position away from the top of the vacuum chamber 112.

A bottom edge of the latex dam sheet 130 is clamped against a rear edge support member 134 with suitable securing means, such as toggle clamps 140. The toggle clamps 140 are mounted on the rear wall member 118 with suitable spacers 141 which provide an appropriate orientation and alignment of the toggle clamps 140 for the desired operation. Three support shafts 142 are 0.75 inches in diameter and are removably mounted within the vacuum chamber 112 by means of support brackets 144. The support brackets 144 are generally equally spaced along the front wall member 116 and the rear wall member 118 and arranged in cooperating pairs. In addition, the support brackets 144 are constructed and arranged to suitably position the uppermost portions of the support shafts 142 flush with the top of the front, rear and side wall members of the vacuum chamber 112. Thus, the support shafts 142 are positioned substantially parallel with one another and are generally aligned with the side wall members 120 and 121. In addition to the rear edge support member 134, the vacuum apparatus 110 includes a front support member 136 and two side support members 138 and 139. Each side support member measures about 1 inch in width and about 1.25 inches in height. The lengths of the support members are constructed to suitably surround the periphery of the open top edges of the vacuum chamber 112, and are positioned to protrude above the top edges of the chamber wall members by a distance of about 0.5 inches.

A layer of egg crating type material 146 is positioned on top of the support shafts 142 and the top edges of the wall members of the vacuum chamber 112. The egg crate material extends over a generally rectangular area measuring 23.5 inches by 14 inches, and has a depth measurement of about 0.38 inches. The individual cells of the egg crating structure measure about 0.5 inch square, and the thin sheet material comprising the egg crating is composed of a suitable material, such as polystyrene. For example, the egg crating material can be McMaster-Carr Supply Catalog No.162 4K 14 (available from McMaster-Carr Supply Company, a business having offices located in Atlanta, Ga. U.S.A.), translucent diffuser panel material. A layer of 6 mm (0.25 inch) mesh TEFLON-coated screening 148, available from Eagle Supply and Plastics, Inc., a business having offices located in Appleton, Wis., U.S.A., which measures 23.5 inches by 14 inches, is placed on top of the egg crating material 146.

A suitable drain line and a drain valve 150 connect to the bottom plate member 119 of the vacuum chamber 112 to provide a convenient mechanism for draining liquids from the vacuum chamber 112. The various wall members and support members of the vacuum apparatus 110 may be composed of a suitable non-corroding, moisture-resistant material, such as polycarbonate plastic. The various assembly joints may be affixed by solvent welding and/or fasteners, and the finished assembly of the tester is constructed to be water-tight. A vacuum gauge 152 operably connects through a conduit into the vacuum chamber 112. A suitable pressure gauge is a Magnahelic differential gauge capable of measuring a vacuum of 0-100 inches of water, such as a No. 2100 gauge available from Dwyer Instrument Incorporated, a business having offices located in Michigan City, Ind., U.S.A.

The thermoplastic foam composites are weighed and wrapped in SCOTT paper towels (manufactured by Kimberly-Clark Corporation, a business having offices located in Neenah, Wis., U.S.A.). Then, the wrapped samples are placed in excess 0.9% NaCI saline solution, submerged and allowed to soak for twenty (20) minutes. After the twenty (20) minute soak time, the absorbent structure is placed on the egg crate material and mesh TEFLON®-coated screening of the Saturated Capacity tester vacuum apparatus 110. The latex dam sheet 130 is placed over the absorbent structure(s) and the entire egg crate grid so that the latex dam sheet 130 creates a seal when a vacuum is drawn on the vacuum apparatus 110. A vacuum of 0.5 pounds per square inch (psi) is held in the Saturated Capacity tester vacuum apparatus 110 for five minutes. The vacuum creates a pressure on the absorbent structure(s), causing drainage of some liquid. After five minutes at 0.5 psi vacuum, the latex dam sheet 130 is rolled back and the absorbent structure(s) are weighed to generate a wet weight.

The overall capacity of each absorbent structure is determined by subtracting the dry weight of each absorbent from the wet weight of that absorbent, determined at this point in the procedure. The 0.5 psi Saturated Capacity or Saturated Capacity of the absorbent structure is determined by the following formula:
Saturated Capacity (g/g)=(Wₜₛ−Wₜₚ−W_{d})/W_{d}
Where: Wₜₛ=Total wet wrapped sample weight including wet paper towel after vacuum
Wₜₚ=Wet paper towel weight
W_{d}=Dry weight of thermoplastic foam composite
   For Saturated Capacity, a minimum of four specimens of each sample should be tested and the results averaged.
   Centrifuge Retention Capacity (CRC) Test

The Centrifuge Retention Capacity (CRC) Test measures the ability of the thermoplastic foam composite to retain liquid therein after being saturated and subjected to centrifugation under controlled conditions. The resultant retention capacity is stated as grams of liquid retained per gram weight of the sample (g/g).

The retention capacity is measured by placing the sample into a water-permeable bag while allowing a test solution (0.9 weight percent sodium chloride in distilled water) to be freely absorbed by the sample. A heat-sealable tea bag material, such as that available from Ahlstrom Corporation of Windsor Locks, Conn., U.S.A., as model designation Dexter 11697 heat-sealable filter paper is suitable. The bag is formed by folding a 12.7 cm by 7.62 cm (5-inch by 3-inch) sample of the bag material in half and heat-sealing two of the open edges to form a 6.35 cm by 7.62 cm (2.5-inch by 3-inch) rectangular pouch. The heat seals should be about 0.635 cm (0.25 inches) inside the edge of the material. After the sample is placed in the pouch, the remaining open edge of the pouch is also heat-sealed. Empty bags are also made to serve as controls. Three samples (e.g., filled and sealed bags) are prepared for the test. The weight of a dry thermoplastic foam composite is about 0.2 to 0.35 grams. The filled bags must be tested within three minutes of preparation unless immediately placed in a sealed container, in which case the filled bags must be tested within thirty minutes of preparation.

The bags are placed between two, polytetrafluoroethylene (e.g. TEFLON material) coated fiberglass screens having 0.5 cm×0.5 cm openings (available from Taconic Plastics, Inc., a business having offices located in Petersburg, N.Y., U.S.A.) and submerged in a pan (length=241.6 cm, width=228.6 cm, height=7.6 cm) of the test solution (approximately 4 liters) at 23 degrees Celsius, making sure that the screens are held down until the bags are completely wetted. After wetting, the samples remain in the solution for about 30±1 minutes, at which time they are removed from the solution and temporarily laid on a non-absorbent flat surface. For multiple tests, the pan should be emptied and refilled with fresh test solution after 24 bags have been saturated in the pan.

The wet bags are then placed into the basket of a suitable centrifuge capable of subjecting the samples to a g-force of about 350. A suitable centrifuge is a HERAEUS LABOFUGE 400 having a water collection basket, a digital rpm gauge, and a machined drainage basket adapted to hold and drain the bag samples. Where multiple samples are centrifuged, the samples must be placed in opposing positions within the centrifuge to balance the basket when spinning. The bags (including the wet, empty bags) are centrifuged at about 1,600 rpm (e.g., to achieve a target g-force of about 290), for 3 minutes. The bags are removed and weighed, with the empty bags (controls) being weighed first, followed by the bags containing the samples. The amount of solution retained by the sample, taking into account the solution retained by the bag itself, is the specific, centrifuge retention capacity (CRC) of the sample, expressed as grams of retained liquid per gram of sample. More particularly, the specific retention capacity is determined in accordance with the following formula:

$$\frac{\begin{matrix}( Sample \& bag weight after centrifuge ) - \\ ( empty bag weight after centrifuge ) - \\ ( dry sample weight )\end{matrix}}{dry sample weight}$$

The three samples are tested and the results are averaged to determine the retention capacity (CRC) of the thermoplastic foam composite. The samples are tested at 23±1 degrees Celsius and 50±2 percent relative humidity.

Thermal Stickiness Index (TSI) Test

The active agent materials (such as superabsorbent particles) were prescreened to have a particle size range from 300 microns to 600 microns. Five grams of the screened active agent materials were weighed and added into a 100 ml PYREX glass beaker. The beaker was gently shaken to form a uniform layer of the active agent materials sample on the bottom of the beaker. The beaker was then placed in a convectional oven at a desired temperature (temperature is dependent upon the thermal-sticky polymer, see Table 2 for example) for 10 minutes. The beaker was taken out of the oven and cooled at room temperature (23±1 degrees Celsius and 50±2 percent relative humidity) for at least 15 minutes until the temperature of the beaker was back to room temperature. Turn the cooled beaker up side down and collect all the active agent materials that fall out of the beaker. Weights of the original amount of active agent materials in the beaker and the amount of active agent materials fallen out of the beaker were used to determine the thermal stickiness index (TSI), in accordance with the following formula:

$$TSI = \frac{{W}_{original} - {W}_{fallen}}{{W}_{original}} \times 100$$

Bending Modulus Test

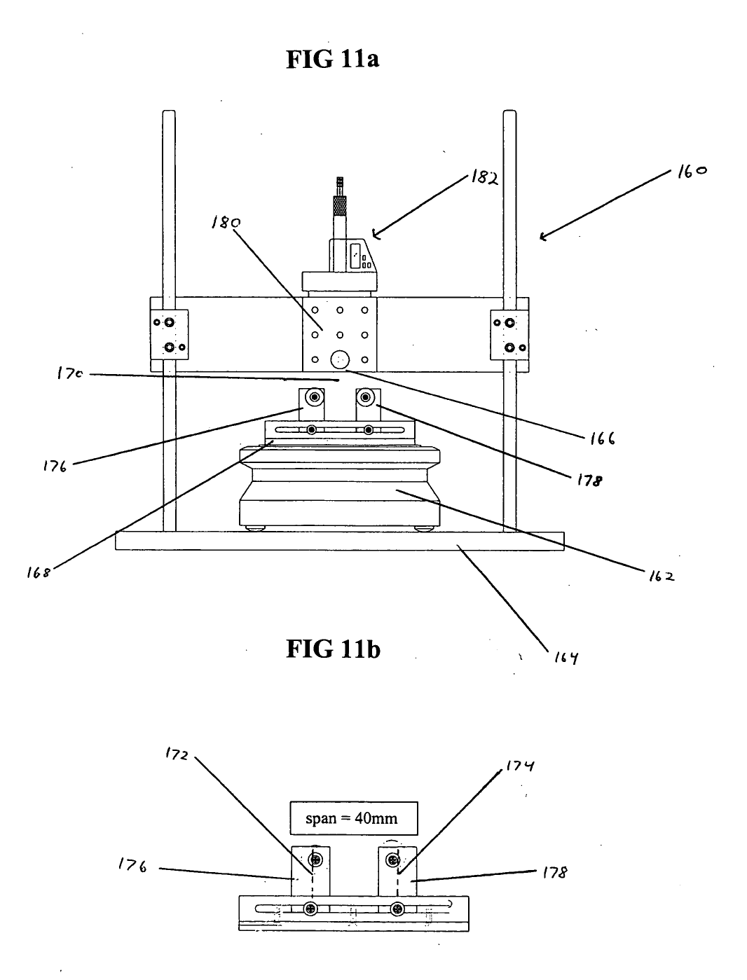

This test is similar to that described in ASTM D 5934. Samples are cut to have dimensions of 64 mm long×38 mm wide (W). The thickness of the sample (T) is then measured in millimeters at 0.05 psi. With reference to FIGS. 11a and 11b, assemble the apparatus 160 so that the balance 162 is completely on the baseboard 164, and the loading nose 166 is centered over the weigh pan 168. The fixture base 170 should be inspected to be sure that the distance between the centers 172, 174 of the two cylinders 176, 178 (S) is 40 mm.

The fixture base 170 should be placed on the weigh pan 168 so that the two cylinders 176, 178 are parallel with the cylinder on the loading nose 166. The caliper 182 should be adjusted to lower the assembly 180 with the loading nose 166 in order to be sure that the loading nose 166 is parallel to the bottom cylinders 176, 178. The sample (not shown) should then be laid across the bottom cylinders 176, 178 with the longer dimension along the span. The loading nose 166 should not touch the sample. At this point, the balance 162 should be tared.

Dial the caliper 182 to move assembly 180 down so that the loading nose 166 just touches the sample and the balance 162 (load) is 0.5 g. Then zero the caliper 182; this will be the reference point for deflection measurements. Set a timer (not shown) for 2 minutes. Dial the caliper 182 to move the loading nose 166 down to 0.25 mm distance (D) then start the timer. (Be sure not to pass 0.25 mm. If it is passed, do not dial back up, simply continue onto the next deflection.) Record the load (F) in grams after 2 minutes. Repeat at other distances of 0.5 mm, 0.75 mm, and 1 mm, then discard the sample. The Bending Modulus (BM) at each deflection can be calculated in g/mm² using the following formula:

$$BM = \frac{F ( {S}^{3} )}{4 D ( {T}^{3} ) W}$$

It will be appreciated that details of the foregoing examples, given for purposes of illustration, are not to be construed as limiting the scope of this invention. Although only a few exemplary embodiments of this invention have been described in detail above, those skilled in the art will readily appreciate that many modifications are possible in the examples without materially departing from the novel teachings and advantages of this invention. For example, features described in relation to one example may be incorporated into any other example of the invention.

Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention. As various changes could be made in the above constructions without departing from the scope of the invention, it is intended that all matter contained in the above description shall be interpreted as illustrative and not in a limiting sense.

What is claimed is:

1. A thermoplastic foam composite comprising at least one active agent layer that is bonded to a surface of a thermoplastic foam layer, wherein the active agent layer comprises active agent materials coated with a thermal-sticky polymer and wherein the at least one thermoplastic foam layer has a saturated capacity of at least 3 grams per gram as measured by the Saturated Capacity Test.

2. The thermoplastic foam composite of claim 1 having a bending modulus of less than 1000 g_{f}/mm2 as measured by the Bending Modulus Test.

3. The thermoplastic foam composite of claim 1 wherein the thermal-sticky polymer is activated by a temperature of at least about 60 degrees Celsius.

4. The thermoplastic foam composite of claim 1 wherein the thermal-sticky polymer is water-soluble.

5. The thermoplastic foam composite of claim 1 wherein the thermal-sticky polymer is selected from modified polyvinyl alcohol, polyethylene oxide, polypropylene oxide, ethylene oxide-propylene oxide copolymer, polyethylene glycol, polypropylene glycol, ethylene glycol-propylene glycol copolymer, modified polysaccharides, such as hydroxypropyl cellulose, methyl cellulose, methyl ethyl cellulose, polyethylene imine or combinations thereof.

6. The thermoplastic foam composite of claim 1 wherein the thermal-sticky polymer has a Thermal Sticky Index of at least 40, as measured by the Thermal Sticky Index Test.

7. The thermoplastic foam composite of claim 1 further comprising an adhesive disposed between the at least one active agent layer and the thermoplastic foam layer.

8. The thermoplastic foam composite of claim 7 wherein the adhesive is selected from pressure sensitive hot melt adhesive, thermal-sticky polymer or combinations thereof.

9. The thermoplastic foam composite of claim 1 wherein active agent materials are present in an amount of at least about 10% by weight of the composite.

10. The thermoplastic foam composite of claim 1 wherein the active agent materials are present in an amount of at least about 60% by weight of the composite.

11. The thermoplastic foam composite of claim 1 wherein the active agent materials are present in an amount of about 30% to about 70% by weight composite.

12. The thermoplastic foam composite of claim 1 wherein the active agent materials are present in a concentration on one surface of the thermoplastic foam layer and the active agent materials are present in a higher concentration on a different surface of the thermoplastic foam layer.

13. The thermoplastic foam composite of claim 1 wherein the active agent materials are selected from superabsorbent materials ion exchange resin particles skin care compounds, perfumes, natural fibers, synthetic fibers, fluid modifiers, odor control particles, cooling agents, heating agents, anti-microbial agents, bactericide and fungicide agents, encapsulated particles containing agents in liquid form, nanoparticles or combinations thereof.

14. The thermoplastic foam composite of claim 1 wherein the thermoplastic foam layer comprises a surfactant.

15. The thermoplastic foam composite of claim 14 wherein the surfactant is present in an amount between 0.05% and 10% by weight of the thermoplastic foam layer.

16. The thermoplastic foam composite of claim 1 wherein the thermoplastic foam layer is subjected to a post-formation treatment.

17. The thermoplastic foam composite of claim 16 wherein the post-formation treatment is selected from hydraulic jet treating, mechanical needling, stretching, drawing, calendaring, creping, brushing, scarfing, buffing, sanding, thermoforming, or combinations thereof.

18. The thermoplastic foam composite of claim 1 wherein the thermoplastic foam layer has a density less than about 0.1 g/cc.

19. The thermoplastic foam composite of claim 1 wherein the thermoplastic foam layer has an open-cell content of at least about 70% by volume.

20. The thermoplastic foam composite of claim 1 having a Centrifuge Retention Capacity of at least about 8 g/g in 0.9% by weight sodium chloride solution as measured by the Centrifuge Retention Capacity Test.

21. The thermoplastic foam composite of claim 1 having a Saturated Capacity of at least about 15 g/g in 0.9% by weight sodium chloride solution as measured by the Saturated Capacity Test.

22. An absorbent composite comprising a superabsorbent material layer that is bonded to a surface of at least one thermoplastic foam layer, wherein the superabsorbent material layer comprises superabsorbent material coated with water-soluble, thermal-sticky polymer, and wherein the at least one thermoplastic foam layer has a saturated capacity of at least 3 grams per gram as measured by the Saturated Capacity Test.

23. The absorbent composite of claim 22 further comprising an adhesive disposed between the superabsorbent material and the thermoplastic foam layer.

24. The absorbent composite of claim 22 wherein the superabsorbent material is present in an amount of at least about 10% by weight of the composite.

25. The absorbent composite of claim 22 wherein the superabsorbent material is present in an amount of about 30% to about 80% by weight of the composite.

26. The absorbent composite of claim 22 wherein the superabsorbent material is present in an amount of about 32.5% to about 70.6% by weight of the composite.

27. An absorbent article comprising:
a topsheet;
a backsheet; and
the thermoplastic foam composite of claim 1 disposed between the topsheet and the backsheet.

28. An absorbent article comprising:
a topsheet;
a backsheet; and
an absorbent composite disposed between the topsheet and the backsheet;
wherein the absorbent composite comprises a superabsorbent material layer that is bonded to a surface of at least one thermoplastic foam layer, wherein the superabsorbent material layer comprises superabsorbent material coated with a water-soluble thermal-sticky polymer, and wherein the at least one thermoplastic foam layer has a saturated capacity of at least 3 grams per gram as measured by the Saturated Capacity Test.
